(19) United States
(12) Patent Application Publication
(10) Pub. No.: US 2007/0022877 A1
(43) Pub. Date: Feb. 1, 2007

(54) ORDERED MESOPORE SILICA MIXED MATRIX MEMBRANES, AND PRODUCTION METHODS FOR MAKING ORDERED MESOPORE SILICA MIXED MATRIC MEMBRANES

(76) Inventors: Eva Marand, Blacksburg, VA (US); Sangil Kim, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/428,647

(22) Filed: Jul. 5, 2006

Related U.S. Application Data
(63) Continuation-in-part of application No. 10/410,599, filed on Apr. 10, 2003, now Pat. No. 7,109,140.
(60) Provisional application No. 60/371,146, filed on Apr. 10, 2002.

(51) Int. Cl. B01D 53/22

(52) U.S. Cl. 95/51

(57) ABSTRACT

Mixed matrix membranes are prepared from mesoporous silica (and certain other silica) and membrane-forming polymers (such as polysulfone), in a void free fashion where either no voids or voids of less than 100 angstroms are present at the interface of the membrane-forming polymer and the silica. Such silica-containing mixed matrix membranes are particularly useful for their selectivity (such as carbon dioxide selectivity) and permeability. Methods for separating carbon dioxide are provided.

### RELATED APPLICATION

This application is a continuation-in-part of U.S. patent application Ser. No. 10/410,599 (now allowed) filed Apr. 10, 2003.

### FIELD OF THE INVENTION

The present invention generally relates to membrane materials and systems for selective removal of specified gases and, more particularly, to a gas separation membrane which employs a zeolite material.

### BACKGROUND OF THE INVENTION

Membrane separations represent a growing technological area with potentially high economic reward, due to low energy requirements and facile scale-up of membrane modular design. Advances in membrane technology, especially in novel membrane materials, will make this technology even more competitive with traditional, high-energy intensive and costly processes such as low temperature distillation and adsorption. In particular, there is need for large-scale gas separation membrane systems, which could handle processes such as nitrogen enrichment, oxygen enrichment, hydrogen recovery, acid gas (CO₂, H₂S) removal from natural gas and dehydration of air and natural gas, as well as various hydrocarbon separations. Materials employed in these applications must have durability, productivity and high separation performance if they are to be economically viable. Currently, polymers' and certain inorganic membranes are the only candidates.

While inorganic membranes have permselectivities that are five times to ten times higher than traditional polymeric materials and moreover are more stable in aggressive feeds, they are not economically feasible for large-scale applications. Most ceramic, glass, carbon and zeolitic membranes cost between one- and three-orders of magnitude more per unit of membrane area when compared to polymeric membranes and furthermore are difficult to fabricate into large, defect-free areas. An advantage of polymeric materials is that they can be processed into hollow fibers, which offer high separation productivity due to the inherently high surface area to volume ratio. Thus, most commercially available gas separating membranes are still made from polymers despite the limited membrane performance.

The following are cited as background regarding mixed matrix membranes and/or gas separation membranes:

U.S. Pat. No. 6,605,140 issued Aug. 12, 2003 to Guiver et al. (National Research Council of Canada) for “Composite gas separation membranes.”

U.S. Pat. No. 6,726,744 issued Apr. 27, 2004 to Kulprathipanja et al. (UOP LLC) for “Mixed matrix membrane for separation of gases.”

U.S. Pat. Application no. 2005/0043167 published Feb. 24, 2005 by Miller et al. (Chevron Texaco) for “Mixed matrix membrane with super water washed silica containing molecular sieves and methods for making and using the same.”

U.S. Pat. No. 6,881,364 issued Apr. 19, 2005 to Vane et al. (U.S. Environmental Protection Agency) for “Hydrophilic mixed matrix materials having reversible water absorbing properties.”

U.S. Pat. Application no. 2006/0107830 published May 25, 2006 by Miller et al. (Chevron Texaco) for “Mixed matrix membrane with mesoporous particles and methods for making and using the same.”

### SUMMARY OF THE INVENTION

It is an object of the invention to provide substantially void free, mixed matrix membranes which include zeolites and polyimides, where the zeolites and polyimides are bonded together by hydrogen, covalent or ionic bonds.

It is another object of the invention to provide methods for making substantially void free, mixed matrix membranes which include zeolites and polyimides.

The class of materials of the present invention are mixed-matrix membranes, which combine the processing versatility of polymers with the molecular sieving capabilities of zeolites. Predictions based on the Maxwell Model and Effective Medium Theory indicate that mixed matrix membranes have superior selectivities and productivities compared to polymers. Furthermore, such composite materials would be compatible with the existing composite asymmetric membrane formation technology and infrastructure. Similar to the current asymmetric composite hollow fibers consisting of an inexpensive porous polymeric support coated with a thin, high performance polymer, the mixed matrix material may consist of an inexpensive polymer hollow fiber coated with a thin polymer layer packed with ordered molecular sieving material. Alternatively, hollow fibers may be directly spun from colloidal dispersions consisting of zeolite particles suspended in a polymer solution. Bundles of the thus formed fibers can be collected together and used as a filter device in large scale gas filtering applications.

Elimination of defects at the molecular sieve/polymer interface and in the control of the film's microstructure at the sub-nanometer level is important. This can be achieved by employing zeolites whose size is in the nanometer range and whose surface is functionalized to promote interaction with the polymer matrix. As the size of the zeolites is reduced to approach that of the polymer chains, the surface area/unit mass of zeolite available for interacting with the polymer increases, allowing the zeolites to be effectively incorporated into the polymer structure. Zeolites can be fabricated with controlled nanometer size distributions and surface functionalization. A series of well-characterized polyimides with pendant carboxylic functional groups along the backbone, is an example of a polymer that can serve as the membrane matrix. These polyimides already have excellent separation properties for various gas mixtures and are thermally stable above 400C in air. In addition members of these series of polymers can be dissolved which enables efficient casting and self assembly methods.

More recently, the invention in a preferred embodiment provides a mixed matrix membrane, comprising a silica (such as, e.g., a MCM-41 silica; a MCM-48 silica; a SBA-15 silica; a SBA-16 silica; a microporous silica; a mesoporous silica; a silica having microporous and mesoporous structure; a well-ordered, high surface area silica; a silica having an external diameter in a range submicron; etc.) and a membrane-forming polymer (such as, e.g., a polyimide; a polysulfone; a cellulose acetate; a polycarbonate; etc.), such as, e.g., inventive mixed matrix membranes including a well-ordered, high surface area silica wherein the silica have a distinct X-ray scattering pattern; inventive mixed matrix membranes including a well-ordered, high surface area silica wherein the silica has surface area of at least 300 square meters/g; inventive mixed matrix membranes including amino groups (e.g., aminopropylsilyl; pyrimidine-propylsilyl; pyrolidine-propylsilyl; polyethyleneimine; etc.) on a surface thereof; inventive mixed matrix membranes which separate carbon dioxide from an environment in which the membrane is placed; inventive mixed matrix membranes including a surface active agent adhered to said silica; inventive mixed matrix membranes wherein the silica and said membrane-forming polymer are bonded to each other by at least one of hydrogen, covalent, and ionic bonds between said surface agent on the silica and said membrane-forming polymer; inventive mixed matrix membranes wherein an interface between said silica and said membrane-forming polymer has voids no bigger than 100 angstroms; inventive mixed matrix membranes wherein an interface between said silica and said membrane-forming polymer is substantially void free; inventive mixed matrix membranes wherein the membrane-forming polymer is a hyperbranched polyimide; inventive mixed matrix membranes wherein the membrane-forming polymer is a linear polyimide; inventive mixed matrix membranes wherein the membrane-forming polymer is a polysulfone; inventive mixed matrix membranes including amino groups (such as, e.g., aminopropylsilyl; pyrimidine-propylsilyl; pyrolidine-propylsilyl; polyethyleneimine; etc.) on at least one of a surface of the polymer and a surface of the silica; inventive mixed matrix membranes wherein the silica is a MCM-41 silica, a MCM-48 silica, a SBA-15 silica or a SBA-16 silica, and the membrane-forming polymer is polysulfone; etc.

The invention in another preferred embodiment provides a method of making a mixed matrix membrane comprising the steps of: combining a membrane-forming polymer (such as, e.g., polysulfone; a membrane-forming polymer that is hyperbranched; a membrane-forming polymer that is linear; etc.) with a silica (such as, e.g., a MCM-41 silica, a MCM-48 silica, a SBA-15 silica; a SBA-16 silica; a microporous silica; a mesoporous silica; a silica having microporous and mesoporous structure; a well-ordered, high surface area silica; a silica having an external diameter in a range submicron; etc.) to form a mixture; casting the mixture onto a support; removing solvent from the mixture; annealing the mixture; and forming a mixed matrix membrane.

In another preferred embodiment, the invention provides a method of making a mixed matrix membrane comprising the steps of: a) coating a substrate with a membrane-forming polymer (such as, e.g., polysulfone; etc.), said polymer being present in an organic solvent (such as, e.g., chloroform; chloride; etc.), said coating step producing a polymer layer; b) coating said polymer layer with a silica (such as, e.g., a MCM-41 silica, a MCM-48 silica, a SBA-15 silica; a SBA-16 silica; a microporous silica; a mesoporous silica; a silica having microporous and mesoporous structure; a well-ordered, high surface area silica; and a silica having an external diameter in a range submicron; etc.), said silica being present in an aqueous solvent, said coating step producing a silica layer on said polymer layer; such as, e.g., inventive methods comprising mixing a mesoporous silica with polysulfone to produce a mixed matrix membrane; etc.

The inventive methods of making a mixed matrix membrane optionally may include a step of functionalizing the silica to include functional groups and/or a step of functionalizing said polymer with functional groups and/or a step of sonicating a solution in which the polymer is dissolved.

### DESCRIPTION OF THE DRAWING FIGURES

The foregoing and other objects, aspects and advantages will be better understood from the following detailed description of the preferred embodiments of the invention with reference to the drawings, in which:

FIG. 1 is a schematic drawing of a mixed matrix membrane immobilized on a porous support;

FIG. 2 is a schematic drawing of a plate like zeolite crystal arrangement with the plates parallel to the membrane surface;

FIG. 3 is a schematic drawing showing the functionalization of a zeolite crystal with an ammonia moiety;

FIG. 4 shows the chemical structures of possible cationic polyelectrolites which can be physisorbed onto a zeolite surface;

FIG. 5 is schematic showing hydrogen bonding between the zeolite amine and the carboxylic acid on the polymer;

FIG. 6 is a schematic drawing showing a hybrid ISAM film with carboxylic acid substituted polyimide that is covalently attached to amine functionalized zeolites (the vertical scale on the porous support is exaggerated to illustrate mechanical interlocking of the polyimide chain with the rough substrate surface;

FIG. 7 is a chemical structure drawing of a repeat unit of 6FDA-6FpDA-DABA;

FIG. 8 includes FTIR spectra for the pure polyimide (bottom), polyimide and untethered ZSM-2 (center), and the mixed matrix solution adjusted for APTES (top);

FIG. 9 is an FESEM image of a 20% weight surface modified ZSM-2 80% weight 6FDA-6FpDA-DABA membrane (the outer edges of both regions were embedded in epoxy in order to obtain the cross-sectional image);

FIG. 10 is a TEM cross-sectional image of a 20% weight surface modified ZSM-2 80% weight 6FDA-6FpDA-DABA membrane;

FIGS. 11A-D are schematic drawings showing the aminopropylsilyl (FIG. 11A), chloropropylsilyl (FIG. 11B), pyrrolidine-propylsilyl (FIG. 11C), and pyrimidine-propylsilyl (FIG. 11D) functionalized mesoporous silica;

FIGS. 12A-C are schematic drawings showing the silylation on external surface (FIG. 12A), chloropropylsilyl modification on internal surface (FIG. 12B), and PEI functionalization of mesoporous silica (FIG. 12C);

FIG. 13 is XRD pattern of MCM-48 silica (FIG. 13A) and nano-sized MCM-41(FIG. 13B);

FIG. 14 shows TEM image of nano-sized MCM-41;

FIGS. 15A-B show FESEM images of MCM-48 at lower (FIG. 15A) and higher (FIG. 15B) magnification;

FIGS. 16A-B show nitrogen adsorption-desorption isotherms of MCM-48 silica (FIG. 16A) and SBA-16 (FIG. 16B) at 77 K;

FIGS. 17A-B are cross-sectional FESEM images of 10 wt % as-synthesized MCM-48/PSF MMSs at lower (FIG. 17A) and higher (FIG. 17B) magnifications;

FIGS. 18A-B are cross-sectional FESEM images of 10 wt % calcined MCM-48/PSF MMMs at lower (FIG. 18A) and higher (FIG. 18B) magnifications;

FIGS. 19A-C are FESEM images of 20 wt % calcined MCM-48/PSF MMMs; FIG. 19A is a cross-sectional view at lower magnification; FIG. 19B shows a discontinuous phase; FIG. 19C shows a continuous silica phase at higher magnification;

FIGS. 20A-B show pathways; FIG. 20A is a discontinuous pathway through MCM-48 (10 wt % of MCM-48 loading); FIG. 20B is a continuous pathway through MCM-48 (20 wt % of MCM-48 loading);

FIGS. 21A-C are gas adorption isotherms for PSF (FIG. 21A), MCM-48 silica (FIG. 21B) and 20 wt % MCM-48 PSF MMMS (FIG. 21C) for nitrogen; and

FIG. 22 are equations.

### DETAILED DESCRIPTION OF THE PREFERRED EMBODIMENTS OF THE INVENTION

The materials of the present invention include highly structured, zeolite/polyimide composite thin film membranes, which have a gas separation performance superior to that of existing polymer-based membranes. Further, the materials of the present invention preferably retain their processing versatility.

There are at least two different fabrication methods that may be used. The first method is to cast thin membrane films directly from colloidal zeolite dispersions mixed in a polymer solution and to use interactions of functional groups on the zeolites with the functional groups on the polymer chains to achieve a highly homogeneous distribution of zeolites in a polymer matrix. In a variation on this method, the polymer may be first functionalized with functional groups (e.g., pendant groups having one or more carboxylic acid moieties), and then these functional groups can be used for interacting with functional groups on the zeolites. The second method is a layer-by-layer film forming technique, which will allow to incorporating molecular sieving zeolites as ordered layers into a polyimide matrix using intermolecular interactions at the zeolite/polymer interface to drive self-assembly.

Materials of the present invention may include precise placement of a specified number of zeolite layers in the film. Furthermore, specific molecular interactions or direct covalent linking may be used to facilitate ordering (or orientation) of the zeolite on the supporting surface and to eliminate or reduce defects at the molecular sieve/polymer interface.

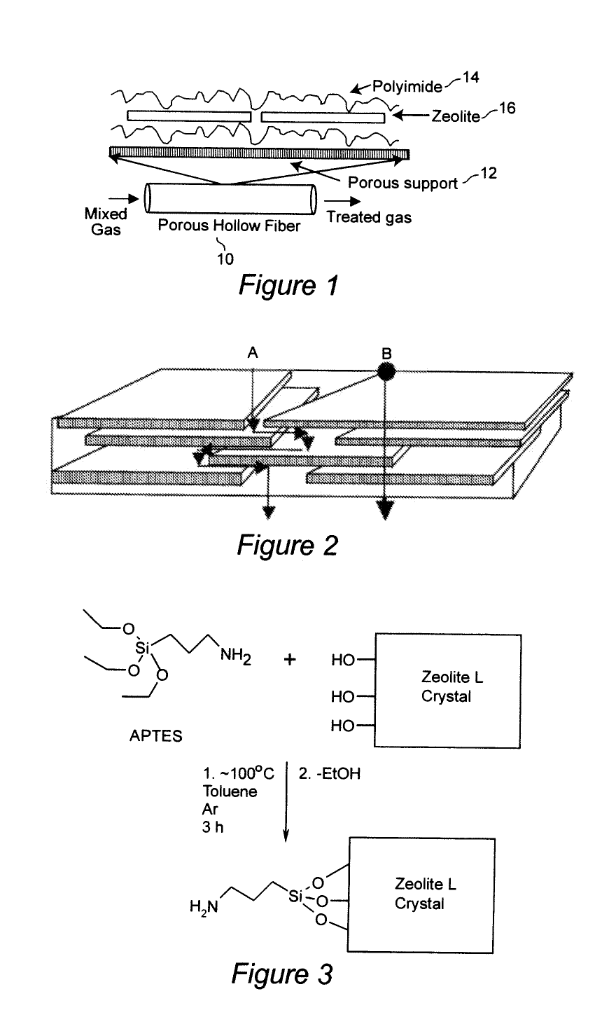

FIG. 1 illustrates an example of composite membrane structure which utilizes a porous hollow fiber 0. The porous support 12 which makes up the hollow fiber 10 can be a variety of different materials (e.g., ceramics, and polymers), but is preferably a porous polyimide (by porous it is meant that the material is permeable to gas) which is thermally matched to the polyimide matrix material 14. Zeolite material 16 is shown sandwiched between the polyimide matrix material 14. That is, the zeolite material 16 and polyimide material 14 are in defined layers or domains, and these layers can alternate many times, as would be the case if the membrane was made from using a self assembly method. The longitudinal axis of the zeolite fragments in the zeolite domain 16 are parallel to the porous support 12. Preferably the zeolite fragments are between 20 nm and 250 nm in length. The zeolite surface can be functionalized with groups such as amines and also can be coated with polyelectrolytes that control the charge of the zeolite fragments.

A feature of the present invention is to have a high aspect ratio where the length of the zeolite fragments is much greater (more than twice) the cross-sectional width which will be exposed to the mixed gas 20. The treated gas 22 emerging from the porous hollow fiber 10 with the internal mixed matrix membrane will have a gas or particulate selectively removed by the zeolite 16 and polyimide 14 with greater proficiency and selectivity than the zeolite or polyimide alone.

The following calculations suggest the use of molecular sieve plate-like particles in the fabrication of mixed matrix membranes. Despite their limitations, calculations based on the effective medium approximation can be used in order to get order of magnitude estimates regarding the potential performance improvement of polymeric membranes from the addition of the zeolite phase. For particles that can be approximated as spherical, the effective permeability can be estimated for dilute systems from:
P_{eff,i}/P_{p,i}={2/P_{z,i}+1/P_{p,i}−2φ_{z}(1/P_{z,i}−1/P_{p,i})}/{2/P_{2,i}+1/P_{p,i}+φ_{z}(1/P_{z,i}−1/P_{p,i})} Eq. 1
where P_{eff,i} is the effective permeability of species-i, in the composite (mixed-matrix) membrane, P_{p,i} and P_{z,i} are the corresponding permeabilities in the polymer and zeolite phase respectively, and φ_{z} is the volume fraction of the zeolite in the mixed matrix material. From this expression, one an easily see that the effective permeability is largely determined by the permeability through the continuous phase, i.e., for the case of mixed matrix membranes, the polymer phase.

For example, consider a likely scenario in which an A-B binary mixture (say nitrogen and oxygen) where the permeability of A in the zeolite is very small so that it can be approximated as zero, and the permeability of B in the zeolite is equal or larger to the permeability of B in the polymer phase. First, we can easily find an estimate for the permeability of A by setting P_{z,A} equal to 0 in Eq. 1:
P_{eff,A}/P_{p,A}=2(1−φ₂)/(2+φ_{z}) Eq. 2
Regarding the permeability of B, P_{eff,B}, it is expected to be at least equal to the permeability of B in the polymer phase, P_{p,B} (for equal permeabilities of B in the polymer and the zeolite), and up to a maximum value of(1+2φ_{z})/(1−φ_{z})(by setting P_{z} to infinity in Eq. 1).

According to the above effective medium calculations considering, for example, a 30% loading the permeability of component A in the mixed matrix membrane, P_{eff,A} is expected to be 61% of the permeability of A in the polymer phase, P_{p,A}. The corresponding estimate for the permeability of B, P_{eff,B} ranges from a value equal to that in the polymer up to at most 2.3 times higher than the permeability in the polymer. As a result, for 30% loading with zeolite crystals that are impermeable to A and highly permeable to B, and have isotropic shapes so that they can be approximated by spheres, the effective medium approximation predictions point to a selectivity enhancement ranging from 1.6 to at most 3.8. Even such small improvements in selectivity can be important in that they enable performance above Robeson's upper bound.

Greater improvements are to be expected when using strongly anisotropic, plate-like zeolite crystals, arranged with their short axis perpendicular to the film surface as drawn schematically in FIG. 2. In such a case, considering a similar scenario as before, i.e, zeolite crystals impermeable to A but permeable to B, one has according to Cussler:
P_{eff,A}{=1+α²φ_{z}²/(1−φ_{z})}⁻¹ Eq. 3

In equation 3, α is the aspect ratio of the plates. Molecular sieve-like particles with channels along the plate thickness and an aspect-ratio between 30 and 100 are utilized. Using the conservative α=30 we find that P_{eff,A} is less than 1% of the permeability of A in the polymer phase. This value becomes even smaller as the aspect ratio increases. This is a dramatic reduction compared to the one calculated for isotropic zeolite particles and could lead to at least a 100-fold increase in selectivity provided that permeation of B along the thickness of the plates proceeds at least as fast as in the polymer phase.

Materials of the present invention preferably may incorporate amsotropic ETS-4, ZSM-2, LTL and MF1 plate-like particles in mixed-matrix membranes. These zeolites are inorganic crystalline structures with pores of the same size as single molecules, and they can separate molecules from a mixture with high selectivity due to the combination of molecular sieving and selective sorption. A unique aspect of zeolites is that they provide high selectivity over a broad range of operating conditions. Furthermore, the surface chemistry of the zeolites may be varied from amphoteric mixed metal oxides to amine-functionalized surfaces. All of these zeolites may be functionalized with appropriate chemical groups to facilitate binding or interaction with the polymer chains (e.g., covalent, hydrogen or ionic bonding). Zeolites are described in more detail in Meier, W. M., Olson, D. H. and Baerlocher C. “Atlas of Zeolite Structure Types”, Zeolites 17(1-2), 1-229 (1996). The zeolites referenced herein can be synthesized using well known techniques to those of ordinary skill in the art.

ETS-4 is a material that, upon appropriate ion exchange and mild thermal treatment below approximately 300° C., can be used for highly selective separations of gases like CH₄/N₂, Ar/O₂, and O₂/N₂. The plate-like crystals are very thin (less than 50 nm) and 10 μm long×5 μm wide, which makes the ideal for enhanced performance mixed matrix membranes as discussed above. ETS-4 is a mixed octahedral/tetrahedral framework with a faulted structure related to the mineral zorite. It can be described as a random inter-growth of four pure hypothetical polymorphs. Due to the faulting, access in ETS-4 is through 8-rings (8R) despite the presence of larger openings in the structure. In this respect, ETS-4 is analogous to small pore zeolites. The framework structure and cation positions of as synthesized ETS-4 (Na-ETS-4) and of Sr ion exchanged ETS-4 has been reported in the published literature. ETS-4 has several distinct features when compared with zeolites as well as other mixed octahedral/tetrahedral frameworks. First is the presence of structural water suggested to exist in the form of bound chains along the channels. Second is the presence of titania octahedra or semi-octahedra that are connected to the rest of the framework through only four oxygen bridges to framework silicon atoms resulting in a planar as opposed to the common three dimensional connectivity encountered in microporous frameworks. As synthesized, Na-ETS-4 has been reported to collapse near 200° C. to an amorphous material. This is attributed to the loss of the structural water chains present along the channel system. Upon appropriate ion exchange (e.g., with Sr) the thermal stability can be extended to temperatures of up to 350° C. Moreover, during heat treatment there is a monotonic decrease in all three crystallographic directions with increasing temperature of dehydration. Crystal structure refinement using powder neutron diffraction data indicate that the unit cell volume decrease is accompanied by a corresponding decrease in the 8R that controls access to the interior of the framework.

The overall three-dimensional crystallographic lattice contraction described above, and the accompanying physical contraction of the 8R that controls the access of adsorbates in the interior of the molecular sieve, sequentially excludes smaller and smaller molecules with increasing temperature of dehydration. Adsorption studies indicate that this is the case and a range of contacted materials that are essentially infinitely selective for important gaseous couples, i.e., N₂ over CH₄, O₂ over N₂, can be prepared. The availability of the plate-like ETS-4 crystals combined with their proven selectivity potential, make them ideal for use in mixed matrix membranes. Moreover, other morphologies of ETS-4 crystals an be prepared ranging from equiaxed crystals to needle-like allowing systematic variations of the zeolite size and shape in the mixed-matrix membrane.

The ZSM-2 is a faujasite related zeolite consisting of continuous blocks (intergrowths) of the cubic FAU and hexagonal EMT structure types (see Atlas of zeolite Structures). ZSM-2 contains silicon as well as aluminum. In order to balance the resulting framework charge (Si has +4 and Al has +3) extra framework cations are present. The kind of the cation can be varied by ion-exchange procedures. The crystals are hexagonal prism shaped with the longest direction being approximately 250 nm. The framework density of Faujasites is around 1.31 g/cm³ and the pore size of Faujasite crystals is approximately 0.74 nm. They can be used for the separation of CO₂/N₂ as well as of mixtures of saturated from unsaturated hydrocarbons. The separations are not based on molecular sieving, but are rather due to preferential adsorption of CO₂ and of the unsaturated hydrocarbon, respectively on the cation sites. For example, benzene/cyclohexane separation factors larger than 100 were recently reported for Na-X zeolite membranes.

Zeolite L has a one-dimensional large-pore system parallel to its c-crystallographic axis. It also contains both aluminum and silicon in the framework and as a result has extra-framework cations that can be ion exchanged to tailor its adsorption properties. Zeolite L can be synthesized in a variety of shapes and sizes ranging from 30 nm particles to flat plates with aspect ratio of at least 100. In the plate-like zeolite L crystals, the one-dimensional channels are running along the thickness of the plates as desired. The availability of other crystal shapes allows systematic variations of mixed matrix membrane microstructure for this zeolite as well.

Zeolite NaA (LTA) and high silica MFI (silicalite-1) may also be used in materials of the present invention. Unfortunately, despite its potential for O₂/N₂ separations, the shape of Zeolite A cannot be manipulated as this zeolite can only be synthesized in spherical or cubic shapes due to its cubic crystallographic symmetry. On the other hand, the shape of silicalite-1 can be manipulated by choice of structure directing agent and growth conditions. Silicalite-1 is an all silica zeolite with the MFI framework topology. The material is hydrophobic with intersecting straight and sinusoidal pores with approximate pore diameter of 0.55 nm. It is highly suitable for separations such as alcohol/water (adsorbing preferentially the alcohol) and of close boiling hydrocarbon isomer (e.g., xylenes, butanes) mixtures. For example, silicalite-1 membranes prepared on porous a-alumina supports show p-xylene to o-xylene separation factors larger than 100. A disadvantage of silicalite-1 is that its synthesis results in the structure-directing agent (tetrapropylammonium ions) in the framework and as a result calcination is required. However, it is possible to calcine silicalite-1 crystals avoiding unwanted agglomeration. A variety of silicalite-1 crystals may be used in the practice of this invention ranging from the 40-100 nm spherically shaped twin nanocrystals, to disk-like and thin coffin-shaped crystals. In the last two morphologies the straight channels, i.e., the faster intra-zeolitic transport pathways, are running down the thin crystal dimension as desired in order to realize the proposed architecture.

Glassy polyimides, i.e., those that have a glass transition temperature above room temperature, are preferably used in the practice of this invention. The ZSM-2 is a faujasite related zeolite consisting of continuous blocks (intergrowths) of the cubic FAU and hexagonal EMT structure types (see Atlas of zeolite Structures). ZSM-2 contains silicon as well as aluminum. In order to balance the resulting framework charge (Si has +4 and Al has +3) extra framework cations are present. The kind of the cation can be varied by ion-exchange procedures. The crystals are hexagonal prism shaped with the longest direction being approximately 250 nm. The framework density of Faujasites is around 1.31 g/cm³ and the pore size of Faujasite crystals is approximately 0.74 nm. They can be used for the separation of CO₂/N₂ as well as of mixtures of saturated from unsaturated hydrocarbons. The separations are not based on molecular sieving, but are rather due to preferential adsorption of CO₂ and of the unsaturated hydrocarbon, respectively on the cation sites. For example, benzene/cyclohexane separation factors larger than 100 were recently reported for Na—X zeolite membranes.

Zeolite L has a one-dimensional large-pore system parallel to its c-crystallographic axis. It also contains both aluminum and silicon in the framework and as a result has extra-framework cations that can be ion exchanged to tailor its adsorption properties. Zeolite L can be synthesized in a variety of shapes and sizes ranging from 30 nm particles to flat plates with aspect ratio of at least 100. In the plate-like zeolite L crystals, the one-dimensional channels are running along the thickness of the plates as desired. The availability of other crystal shapes allows systematic variations of mixed matrix membrane microstructure for this zeolite as well.

Zeolite NaA (LTA) and high silica MFI (silicalite-1) may also be used in materials of the present invention. Unfortunately, despite its potential for O₂/N₂ separations, the shape of Zeolite A cannot be manipulated as this zeolite can only be synthesized in spherical or cubic shapes due to its cubic crystallographic symmetry. On the other hand, the shape of silicalite-1 can be manipulated by choice of structure directing agent and growth conditions. Silicalite-1 is an all silica zeolite with the MFI framework topology. The material is hydrophobic with intersecting straight and sinusoidal pores with approximate pore diameter of 0.55 nm. It is highly suitable for separations such as alcohol/water (adsorbing preferentially the alcohol) and of close boiling hydrocarbon isomer (e.g., xylenes, butanes) mixtures. For example, silicalite-1 membranes prepared on porous a-alumina supports show p-xylene to o-xylene separation factors larger than 100. A disadvantage of silicalite- 1 is that its synthesis results in the structure-directing agent (tetrapropylammonium ions) in the framework and as a result calcination is required. However, it is possible to calcine silicalite-1 crystals avoiding unwanted agglomeration. A variety of silicalite-1 crystals may be used in the practice of this invention ranging from the 40-100 nm spherically shaped twin nanocrystals, to disk-like and thin coffin-shaped crystals. In the last two morphologies the straight channels, i.e., the faster intra-zeolitic transport pathways, are running down the thin crystal dimension as desired in order to realize the proposed architecture.

A series of polyimides that may be used in the present invention are based on 6FDA-6FpDA polyimides (e.g., 6-FDA-6FpDA-DABA, where 6FDA is 4,4′-hexafluoroisopropylidenediphthalic anhydride and 6FpDA is 3,5-daiminobenzoic acid and DABA is 3,5-diaminobenzoic acid), having various contents of pendant carboxylic acid side groups and a molecular weight around eighty thousand. The synthesis of these materials can be carried out by a number of techniques and has been reported in the published literature. The molar proportion of the anhydride to the acid is 1:1. The ratio of the two acids is varied from 0 to 100%. As can be seen in Table 1, these polymers already have excellent transport properties. ESCA results indicate that as the proportion of the diarninobenzoic acid used in the synthesis increases, the concentration of carboxylic groups present on the film surface increases. As the concentration of the carboxylic groups along the backbone increases, the overall permeabilities of the polymers decrease as a result of hydrogen bonding between the chains. These polyimides are soluble in solvents such as tetrahydrofuran (THF) and CH₃Cl and can be cast into highly durable films. The thermal stability of these polymers extends up to 500° C. under nitrogen atmosphere and up to 400° C. in air.

TABLE 1
6FDA-6FpDA/DABA polyimides; physical data and permeation
properties^{c}

| % DABA^{a} | O/F^{b} ratio | CO₂ | CH₄ | O₂ | N₂ | He |
|---|---|---|---|---|---|---|
| 0 | 0.42 | 62.1 | 1.72 | 15.6 | 3.39 | 135 |
| 8 | 0.58 | 54.7 | 1.34 | 12.9 | 2.71 | 120 |
| 16 | 1.65 | 36.6 | 0.94 | 9.2 | 1.92 | 94 |
| 32 | 2.00 | 25.4 | 0.58 | 6.5 | 1.24 | 80.7 |
| 100 | 3.19 | — | — | — | — | — |

^{a}The % DABA (diaminobenzoic acid) reflects the molar ratio of DABA to 6FpDA during synthesis. The carboxylic acid content in the polymer increases proportionately with the DABA content.
^{b}The ratio of oxygen to fluorine atoms (O/F) is calculated from ESCA studies of the film surface composition and is largely dependent on the casting conditions. For the ESCA studies, all films were cast from THF solution.
^{c}The gas permeation properties are reported in Barrers (10⁻¹⁰ ((cm³ at STP)cm)/(cm²scmHg))) and were collected at 35° C.

Finally, hydrocarbon separations require a polymer matrix, that is not susceptible to plasticization. A study of the permeation and separation behavior of several polyimide membranes to olefin/paraffin separations has shown that 6FDA-based polyimides have a relatively high performance when compared to other types of polyimides. For example, the reported permeabilities for propylene were PC_{3H6}=20-40 Barrers and an ideal separation factor α_{id}=(C₃H₆/C₃H₈)=11 at 323°K and 2 atm. However separation factors obtained using mixed gases were lower by 40% due to the plasticization effect. In the present case, since the polymer is effectively cross-linked with the zeolite particles in the mixed matrix membrane, the plasticization effect is minimized. Mixed matrix membranes based on silicalite (α=100 for butane/iso-butane) and the hexafluorinated polyimide are useful in butane/iso-butane separations.

In addition, within the practice of this invention, commercially available polyimides may be functionalized with functional groups (e.g., carboxylic acids) using reagents which will append moities containing carboxylic acid along the backbone of the polyimide. This would avoid having to synthesize the polyimides and/or purchase the 6FDA type polyimides described above. In addition, commercially available polyimides, modified with carboxylic acid moieties, for example, might provide enhanced properties such as toughness, flame retardance, resistance to creep, temperature resistance, and solvent resistance. Moreover, polymers other than polyimides (e.g., polyamides, polyethers, polyesters, polyurethanes) might be employed in the practice of this invention provided they are compatible with zeolites, and include or are functionalized to include functional groups (e.g., carboxylic acids) on their backbone which hydrogen bond, covalently bond or ionically bond with functional groups on the zeolite and provide a substantially void free interface between the zeolite and the polymer (i.e., no voids or voids present that are no larger than 100-500 nanometers).

Membrane fabrication according to the invention may employ two different approaches for combining functionalized zeolites with functionalized polyimides. The first approach involves blending the desired concentrations of each component in a common solvent or solvents combination and then casting a film from the resulting solution. These processes preferably have zeolite/polymer ratios from 20 to 50% by volume. The second approach makes use of a layer-by-layer self-assembly process originally developed for ionically self-assembled monolayers (ISAM's). This approach allows the making of thin zeolite/polyimide membranes (less than 100 nm) on a microporous support (e.g., a support which is permeable by gas, such as a support having nanovoids) at volume fractions of zeolites approaching the close packing limit, i.e., greater than 60% by volume. Precise placement of a specified number of zeolite layers in the film makes it possible to attain unprecedented control of the membrane microstructure and hence gas separation performance. Without intending to be bound by theory, the plate-like zeolites are believed to orient with their flat surfaces parallel to the support during deposition, due to capillary and surface forces.

Functionalization of the zeolite surface may be achieved by tethering, silanation or by physisorption of polyelectrolytes onto the zeolite. One embodiment of the present invention includes silanating the ZSM-2 zeolites (for example) with aminopropyltriethoxysilane (APTES), which introduces an amine group on the zeolite surface. FIG. 3 illustrates this embodiment. Before mixing the zeolite with polymer, the zeolite surface is chemically altered to promote adhesion between the polymer and the zeolite. The zeolite is added to toluene and allowed to disperse by stirring. APTES is later added to the mixture. The ratio of reactants is 50 mg of zeolite: 10 ml toluene:0.66 ml APTES. The mixture is then heated until the toluene refluxes (100-110° C.). A wide variety of other silane coupling agents may also be used in the practice of this invention and would employ similar procedures. In addition, the zeolite may be functionalized with more than one functional group (e.g., two or more amine moieties (or two or more carboxylic acid moieties if the polyimide or other polymer is functionalized with amine moieties)). This example, where the zeolite is functionalized with amines, takes advantage of an acid-base salt formation between the carboxylic acids on the polymide and amine bases adhered on the zeolite.

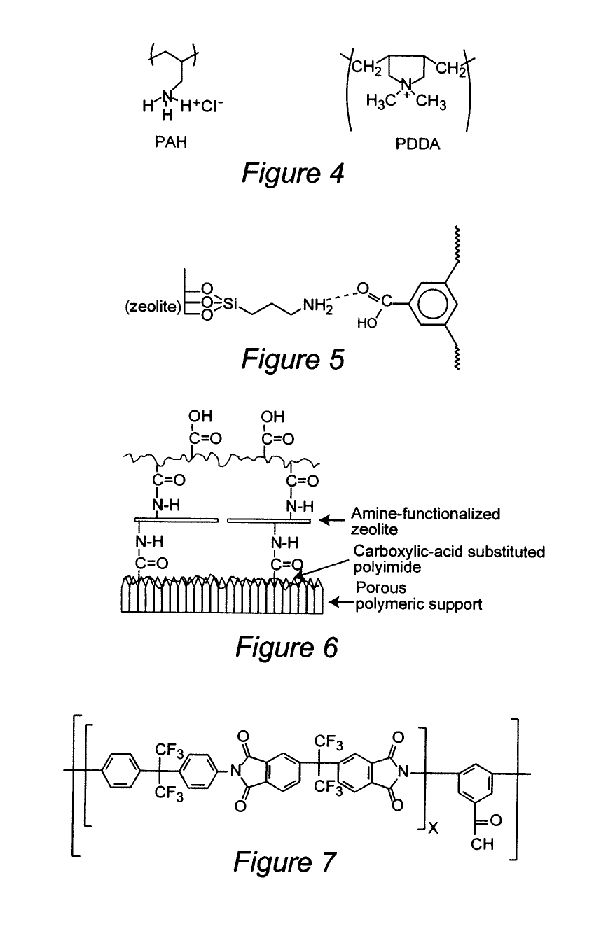

Physisorption of polyelectrolytes to the zeolites occurs by electrostatic attraction between oppositely charged zeolites and polymer chains. This is readily achieved by mixing cationic polyelectrolytes such as poly(allylamine hydrochloride), PAH and polydiallyl dimethylammonium chloride, PDDA (general structures shown in FIG. 4) with zeolite suspensions in water at a pH greater than the isoelectric point (IEP) of the zeolite where the net charge on the zeolite is negative. Zeolite A has an IEP of approximately 5. The sign of the zeta potential of aqueous zeolite A suspensions can be changed via the addition of PDDA. The addition of PDDA at a weight concentration as low as 0.1% w/w PDDA/zeolite was sufficient to change the zeta potential of the zeolite from an initial value of −40 mV to +20 mV.

Another approach is through direct blending. This approach introduces functionalized zeolites into a polyimide solution in a fashion that achieves a homogeneous distribution of zeolites in the polyimide matrix. Solvent may include THF, acetone and CH₃Cl. The strength of hydrogen bonding between the amine group on the zeolite (whether tethered or physisorbed using a surface active agent) and the carboxylic acid group found along the polyimide backbone may vary with the type of solvent, the relative composition of the mixed matrix and the solution concentration. FIG. 5 shows the schematic of this interaction. For most hydrogen-bonded complexes, the hydrogen bonding strengths decrease as the solvent changes from aliphatic hydrocarbon to chlorinated hydrocarbon, to a highly polar liquid. The strong adsorption of the polyimide to the functionalized zeolite lead to colloidal dispersion and stabilization of the zeolites. The strength of the hydrogen bonding interaction may be studied directly by Fourier Transform Infrared Spectroscopy (FTIR) and indirectly by rheological measurements. Rheological measurements are very sensitive probes of particle-polymer interactions in suspension. Attractive interactions between zeolites can lead to the formation of a gel-like network, causing the suspension viscosity to increase markedly and to show significantly more shear thinning. Colloidal dispersion of the zeolites by the adsorption of polyimides suppress network formation, causing the suspension viscosity to decrease. The storage modulus G′ will become much greater than the loss modulus G″ as well. The static modulus will become progressively larger as the suspension becomes more flocculated.

While FIG. 5 shows a hydrogen bonding interaction, it should be understood that the zeolite can be joined to the polymer chain by a covalent bond or through ionic bonds in similar fashion.

A mixed matrix membrane based on 20/80 (zeolite/polymer) volume composition of silicalite in 6FDABA-32 polyimide was examined using scanning electron microscopy. The surface of the zeolites was tethered with 3-aminopropyltriethoxysilane. The membrane was formed by casting a 5 wt % solution of zeolitespolymer-THF onto Teflon plates and allowing the solvent to slowly evaporate over a six day period. The resulting film was highly homogenous and self-supporting and the SEM image showed well-dispersed zeolites in a coherent polymer matrix with good interfacial contact. FTIR studies revealed that hydrogen bonding occurs between the amine groups on the tethered zeolites and the carboxylic groups pendant on the polymer chain. Both the polyimide and mixed matrix films were cast from THF. Comparison studies of the spectra (at two different frequency ranges) of the pure polylmide with the spectra of a polyimide obtained by subtracting a spectrum of a tethered zeolite from a spectrum of a mixed-matrix system were performed. Hence, the subtracted spectra should reflect the polyimide in a mixed matrix environment. Both the hydroxyl and carbonyl regions showed evidence of hydrogen bonding in the mixed matrix system. For example, a peak at 3085 cm⁻¹, representative of a self-associated carboxylic acid dimer, decreased substantially when the functionalized polyimide was in a mixed matrix environment. The free O—H stretch, a band at 3500 cm⁻¹, was absent in the subtracted spectrum. Instead, we saw a peak at 3270 cm⁻¹ which corresponds to singly hydrogen bonded hydroxyl groups. In the carbonyl region, we not only saw a slight shift of the carbonyl band to lower wavenumbers, but also the appearance of a whole new band at 1670 cm⁻¹ associated with carbonyl moieties hydrogen bonded to an amine. We were not able to distinguish between the carbonyl groups in carboxylic acid dimers and the imide carbonyls because of band overlap. Nevertheless, our results showed that during the dissolution step, self-associated carboxylic groups break up and (along with any free carboxylic groups) subsequently hydrogen bond with the more accessible amine groups tethered to the zeolite surface. Enhanced hydrogen bonding may be achieved if pendant groups having two or more functional groups (amines or carboxyilic acids) were employed.

The layer-by-layer technique involves the deposition of monolayers of oppositely charged or chemically complimentary polymers and zeolite crystals to form composite films with control of the composition at the 1-5 nm scale. This is readily done at ambient conditions with simple and inexpensive equipment. The membrane includes a thin polymeric film with a homogeneous distribution of zeolite particles, supported by a porous polymer support (either commercially available polypropylene or a polyethenimide from GKSS, Germany) with minimal transport resistance. This procedure reduces the formation of defects and pinholes and permits control of the placement of the zeolite particles, as deposition occurs one monolayer at a time, driven by the specific molecular interactions. In addition, this approach permits higher zeolite loading capacities into the mixed matrix membrane than simple blending.

A variation of the ISAM process in which attractive electrostatic and hydrogen bonding interactions drive self-assembly may be used to form zeolite/polyimide films. The organo-soluble polyimide that is functionalized with carboxylic acid groups (e.g. 6FDABA-32) is deposited onto a substrate from an organic solution. The excess polyimide is rinsed away to leave a monolayer of adsorbed polyimide. The polyimide—coated substrate is then dipped into an aqueous dispersion of zeolite crystals functionalized with physisorbed polycations such as PAH or with covalently attached amines from silanating reactions. The carboxylic acid groups on the polyimide will lead to strong interaction between the zeolite surface and the polyimide by electrostatic interactions and by hydrogen bonding.

For example, when the zeolite is deposited from an aqueous suspension in the pH range 6<pH<8, the secondary amine groups on the PAH (physisorbed to the zeolite) strongly interact with the carboxylic acid groups electrostatically. When the zeolite is deposited from an aqueous suspension at pH=4 which is the pKa of the carboxylic acid on the polyimide, then 50% of the carboxylic acid groups on the polyimide surface will be charged and the other 50% will be uncharged. Under these conditions, electrostatic attractive interactions will occur between the dissociated acid and the protonated PAH. In addition, hydrogen bonding will occur between the undissociated —OH groups on the carboxylic acid and the PAH. The strength of the hydrogen bonding and electrostatic interactions in these films will be characterized using FTIR spectroscopy as a function of the carboxylic acid group content in the polyimide.

Once the zeolite layer is deposited onto the polyimide-coated substrate, another layer of polyimide is deposited onto the film by dipping the film into the polyintide solution in an organic solvent. Hydrogen bonding interactions between the amine-functionalized zeolite and the carboxylic acid groups on the polyimide will drive adsorption. The dipping process can then be repeated to build up, layer-by-layer, a mixed zeolite-polyimide film with an arbitrary number of zeolite-polyimide bilayers with precise placement of the zeolite at specified layers.

Another scheme that may be utilized is to covalently link functionalized zeolites to polymer chains to improve membrane mechanical stability and reduce defects at the zeolite/polyimide interface. Zeolites with secondary amine functionalities react with pendant carboxylic groups on the carboxylic acid-substituted polyimide, using heterobifunctional crosslinkers as shown in FIG. 6. One suitable heterobifunctional crosslinker is EDC [1-Ethyl-3-(3-Dimethylaminopropyl)-carbodiimide hydrochloride]. EDC is water-soluble and, at room temperature and pH=5-7, activates the carboxylic acid into a more reactive ester intermediate, which facilitates the nucleophilic attack of the amine group; NHS (N-hydroxysuccinimide) is added to stabilize the reactive intermediate until this nucleophilic attack occurs. The resulting crosslink is an amide bond. EDC is known as a “zero-length crosslinker” since it does not introduce any spacer groups between the carboxylic acid and amine groups. The process can be repeated for subsequent layers. By varying the number of carboxylic groups along the back-bone of the polyimide, the permeation properties of the resulting membranes may vary.

The composition and morphology of the surface layers of the membranes may be characterized by contact angle measurements, X-ray Photoelectron Spectroscopy (XPS), X-ray diffraction, atomic force microscopy (AFM), and scanning electron microscopy (SEM) to ensure controlled, reproducible chemistries. This characterization may be done after each surface treatment step and each film layer deposition step. Contact angle measurements provide a sensitive probe of the outermost atomic layers on a surface. Preferably the dipping solutions, organic or aqueous, wet the substrates and subsequent films to ensure homogeneous film deposition.

X-ray diffraction, including pole-figure measurements, may be used for phase identification and determination of the orientation of the zeolite crystals. XPS may be used to probe the topmost 1.5-5 nm of the films and provide detailed information about bonding states and also composition by atomic ratio. This technique may be used for verifying the proper surface chemistries of the substrates prior to membrane deposition as well as for tracking polyimide and zeolite deposition in conjunction with contact angle measurements and UV-Vis spectrophotometry. Auger spectroscopy provides depth profile information at depths of greater than 5 nm. AFM and SEM may be used to characterize the film morphology and to detect any film defects, which would be related to inhomogeneities in the film formation steps. AFM provides a particularly useful diagnostic test for film homogeneity and reproducibility since, in the tapping mode, AFM can routinely characterize polymer film morphology with a height resolution of ±0.1 nm.

The polymer deposition per dipping step can be followed by UV-Vis spectrophotometry, fluorescence spectroscopy, and by FTIR microscopy. In all of the approaches for making films, the amount of deposited polymer is preferably the same for each layer. Thus the amount of deposited polymer should increase linearly with the number of deposited layer. The thickness of each deposited layer can be measured by variable angle ellipsometry to provide measurements of film thicknesses with a resolution of ±0.2 nm.

The results of the aforementioned physical characterization studies can be correlated with gas permeability measurements. Specifically, permeabilities of gases such as Ar, CO₂, N₂, O₂, H₂ and CH₄ and hydrocarbons, such as propane and butane, can be determined as a function of temperature and pressure.

One problem encountered in developing mixed matrix membranes for gas separations has been the poor contact between rigid polymers and zeolites at the interface. This phenomenon leads to voids and other defects within the membrane resulting in poor separation performance. The present invention includes a method, which encourages adhesion at the interface and is aimed at fabricating mixed matrix membranes composed of a polyimide and functionalized zeolite.

High molecular weight functionalized polylmide polymers (i.e. 93,000 g/mol) were synthesized for the purpose of fabricating a mixed matrix membrane. The polyimide 6-fluorodianhydride-6-fluoro-p-diamine-diaminebenzoic acid, or 6FDA-6FpDA-DABA, was produced by reacting, a dianhydride, a diamine, and a diamino acid in a step growth reaction. FIG. 7 shows a 6FDA-6FpDA-DABA repeat unit. This polymer was mixed in solution with zeolites and cast as a thin film to fabricate the mixed matrix membrane (MMM). ZSM-2 nanocrystals are composed of silicon-oxygen bonds in a cyclic hexagonal as confirmed by FESEM image. The zeolites were functionalized to provide secondary forces between the zeolites and the polymer, achieving good adhesion between the two components. Aminopropyltriethoxysilane (APTES) was added to a zeolite-toluene solution and refluxed under an Argon atmosphere to add a primary amine to the zeolite. The reaction is illustrated in FIG. 3 and is discussed above. The tethered zeolites were then added into a polymer-tetrahydrafuran mixture. MMMs containing 20/80 weight % zeolite/polymer as well as 50/50 weight % zeolite/polymer were fabricated.

The step taken from FIG. 3 to produce a mixed matrix membrane depends on which method of fabrication is used. Exemplary procedures for (1) solution casting, or (2) doctor blading are set forth below.

Solution casting involves casting a mixture of zeolite, polymer and solvent onto a surface (preferably polytetrafluorethylene (PTFE) coated) and allowing the solvent to evaporate. Once the zeolites have been modified using APTES and isolated into THF or other suitable solvent, the steps of this procedure may include:
1) Add the polymer to the zeolite-THF mixture. The amount of polymer added depends on the desired final content of the mixed matrix membrane (e.g., the desired zeolite weight percent of the final membrane).
2) If necessary, add THF so the mixture has between 1-5% solids content. Solids content is the weight of the zeolite and the polymer divided by the weight of the zeolite and polymer and THF.
3) Cast this mixture onto a clean Teflon coated pan. Cover the pan with a glass plate to slow the evaporation of the solvent.
4) When the solvent has evaporated (usually 1-2 days), remove the glass plate.
5) Begin an annealing procedure.

Doctor blading involves casting a more viscous solution onto a surface (preferably PTFE coated) and allowing the solvent to evaporate. For example, once the zeolites have been modified using ATPES and isolated into THF, the steps for this procedure may be:
1) Add the polymer to the zeolite-THF mixture. The amount of polymer added depends on the desired final content of the mixed matrix membrane (e.g., the desired zeolite weight percent of the final membrane).
2) If necessary, add or remove THF so the mixture has roughly 25% solids content. Solids content is the weight of the zeolite and the polymer divided by the weight of the zeolite and polymer and THF.
3) Cast the solution onto a PTFE coated surface.
4) Use a doctor blade with a preset height to smooth out the casted mixture.
5) Cover the surface with a glass plate to slow the evaporation of the solvent.
6) When the solvent is evaporated (typically 12 hours), remove the membrane and being the annealing procedure.
   Exemplary annealing procedure.
1) Place the membrane under vacuum at a temperature of 50° C. for 5 hours.
2) After 5 hours at 50° C., raise the temperature to 150° C. for 5 hours.
3) After 5 hours at 150° C., raise the temperature to 220° C. for 12 hours.
4) After 12 hours at 220° C., turn off the heater and allow the membrane to cool to room temperature while still under vacuum.
5) When the membrane reaches room temperature, remove the vacuum.

An exemplary procedure for making a mixed matrix membrane composed of self assembled monolayers is as follows, and begins with the polymer in a thin film form, and zeolites have preferably previously undergone a reaction with a surface active agent as discussed above in conjunction with FIGS. 3 and 4: 1) Disperse chemically altered zeolites into a liquid; 2) Immerse the polymer film into the same liquid; 3) Slowly withdraw the polymer from the film; this will leave a zeolite coating on the polymer; 4) Allow to air dry; 5) When dry, dip the zeolite coated film into a solution containing dissolved polymer, and slowly remove; 6) Allow to air dry; 7) Repeat steps 2-6 as many times as necessary to reach desired number of zeolite and polymer layers.

The method described herein should work for any polymer and zeolite combination, provided the two are capable of interacting with each other. Because most zeolites have hydroxyl groups on their surface, they can be modified using the same reaction shown in FIG. 3. This allows one to develop a MMM for specific gas separation by choosing a zeolite intended for that separation. Examples of zeolites that could be used in for developing MMMs are Zeolite 4A, ZSM-2, Silicalite, Zeolite L, and ETS-4. Additionally, the reaction used to modify the zeolites can use a reactant other than APTES. N-(2-aminoethyl)-3 -aminopropyltriethoxysilane, N-(6-aminohexyl)aminopropyltrimethoxysilane, and (3-trimethoxyzilypropyl)diethylenetriamine are other reactants that could be used to functionalize the zeolites. In addition, the modified zeolites and functionalized polymer could be made to react with each other, resulting in a covalent bond between them as opposed to simply interacting through secondary forces. There are many polymers that can be synthesized to posses groups capable of interacting through secondary forces with the modified zeolites, or react with the modified zeolites.

### EXAMPLE 1

Mixed Matrix membranes of 6FDA-6FpDA-DABA, a glassy polyimide, and modified zeolites (ZSM-2) were successfully fabricated using the procedure outlined in this paper. The membranes were cast from solution, and then exposed to different gases for the purpose of determining and comparing the diffusivity coefficients, the solubility coefficients, and the permeation rates of He, O₂, N₂, CH₄ and CO₂ of the pure polyimide and the composite membrane.

FTIR spectra were collected from the pure polyimide, the polyimide and untethered zeolite solutions, and the mixed matrix membrane (MMM) solution. Comparison of the spectra revealed the presence of hydrogen bonding in the MMM solution not present in the other samples. FESEM images and TEM images did not reveal the presence of voids between the polymer and the zeolite. These images also revealed that when given ample time for the solvent to evaporate, the zeolites sediment to one side of the membrane. This develops a polymer rich phase and a zeolite rich phase, and many of the ZSM-2 zeolites appear to adopt an orientation with their largest face orthogonal to the direction of the gas flow.

Several research efforts intended on surpassing the Robeson's 1991 upper bound trade off curve [Robeson, L.; J. Membrane Sci. 1991, 62, 165] have focused on the development of mixed matrix membranes, which combine the outstanding separation performance of the zeolites with the processing capabilities and low cost of polymers. Potential applications of these new membranes have been discussed elsewhere [Koros, W. J. ; Mahajan, R.; J. Membrane Sci. 2000, 175, 181]. Mixed Matrix Membranes (MMM) developed from rubbery polymers and zeolites have been fabricated and characterized, showing enhanced separation behavior [Tantekin-Ersolmaz, S. B.; Atalay-Oral, C.; Tather, M.; Erdem-Senatalar, A.; Schoeman, B.; Sterte, J.; J. Membrane Sci. 2000, 175, 258; Mahajan, R.; Koros, W. J.; Ind. Eng. Chem. Res. 2000, 39, 2692; Zimmerman, C.; Singh, A.; Koros, W. J.; J. Membrane Sci. 1997, 137, 145]. However, attempts at fabricating MMM using glassy polymers and zeolites resulted in presence of voids at the polymer-zeolite interface, this reducing the separation performance of the composite membrane relative to the pure polymer [Mahajan, supra; Zimmerman, supra]. To overcome these defects, several different silane coupling agents were successfully employed to improve adhesion between the polymer and zeolite, however, the resulting permeabilities were slightly lower, and ideal selectivities were largely unchanged when compared to the pure polymer [Tantekin-Ersolmaz, supra; Mahajan, supra; Zimmerman, supra].

Other attempts at developing glassy polymer-zeolite composite membranes have focused on fabrication methods without modifying the zeolite surface. Gür combined molecular sieve 13× and polyethersulfone (PES) through a melt extrusion process [Gür, T.; J Membrane Sci. 1994, 93, 283]. The two components were dried and extruded through a thin slit die to produce defect free membranes. However, the resulting membrane's permeation properties did not change significantly relative to the pure PES membrane. Süer et al simply mixed polyether-sulfone with either zeolite 13× or zeolite 4A and solution cast the mixture [Süer, M.; Baç, N.; Yilmaz, L.; J. Membrane Sci. 1994, 91, 77]. However, they used three different solution drying and annealing procedures to fabricate the membranes, one of which resulted in improved permeability and selectivity relative to the pure PES. Yong et al developed interfacial void free polyimide mixed matrix membranes by using a low molecular weight chain capable of hydrogen bonding with both the polymer and zeolite [Yong, H. H.; Park, H. C.; Kang, Y. S.; Won, J.; Kim, W. N.; J. Membrane Sci. 2001, 188, 151]. This chain essentially enhanced the contact between the two components. The resulting membranes displayed increased permeability without much change in the selectivity.

Herein, a method is presented to fabricate defect free mixed matrix membranes, relying on the hydrogen bonding interaction between amine terminated silane coupling agents that are tethered onto zeolite surfaces, and acidic groups incorporated into the polyimide backbone.

Experimental

The synthesis and characterization of the 6FDA-6FpDA-DABA polyimide is described elsewhere in detail [Cornelius, C. J.; Ph.D. Dissertation, Virginia Tech, 2000.] The polymer is based on 75 mol % 4, 4′-hexafluoroisopropyl-idene dianiline (6FpDA) and 25 mol % diaminobenzoic acid (DABA) and has a weight average molecular weight 93,000 g/mol. The repeat unit of polyimide is shown in FIG. 7. ZSM-2 zeolite was synthesized as described elsewhere [Nikolakis, V.; Xomeritakis, G.; Abibi, Ayome.; Dickson, M.; Tsapatsis, M.; Vlachos, D. G.; J. Membrane Sci. 2001, 184, 209]. ZSM-2 is regarded as a faujasite type zeolite. The structure of ZSM-2 contains both Si and Al, therefore a cation was needed to balance the charge; the cation chosen was Li. The ratio of Si/Al falls between 1-1.5, which catagorizes the zeolite as a Na—X form of faujasite. The ZSM-2 crystals posses a hexagonal shape with the longest direction ˜250 nm, and a pore size of 0.74 nrm. The framework density of faujasites is ˜1.31 g/cm³.

Once synthesized, the zeolites were centrifuged and their aqueous solution was replaced with toluene. The mixture was added to a round bottom flask, and more toluene was added to provide a zeolite concentration of 6.2 mg/ml toluene. Aminopropyltriethoxysiliane (APTES) was then added such that a ratio 0.08 ml APTES/ml toluene was present in the flask before the reaction began. The mixture was then refluxed under an Argon purge for 2 hours. The reaction is outlined in FIG. 3.

Upon completion of the reaction, the mixture was centrifuged several times, each time replacing the solvent with tetrahydrafuran (THF). An amount of 6FDA-6FpDA-DABA required to produce a 20% weight ZSM-2, 80% weight polyimide mixed matrix membrane was added to the zeolite-THF mixture and allowed to mix for 24 hours. The solution was then cast onto a PTFE coated surface and allowed to evaporate over a two day period.

The gas permeabilities of the pure polyimide and mixed matrix membrane were measured in a constant volume—variable pressure system. Using the time lag method, the permeability, diffusion coefficient, solubility coefficient, and theta time for both membranes were determined for He, O₂, N₂, CH₄, and CO₂. The gases were tested in that order for all membranes. The ideal selectivities were calculated using the pure gas permeabilities.

The changes in the chemical environment among the pure polyimide, the polyimide and untethered ZSM-2, and the mixed matrix solution were investigated by analyzing FTIR spectra (BIO-RAD, FTS-40A). The samples were prepared and tested as thin films. The presence of hydrogen bonding between the zeolite and polymer were determined by observing shifts to lower wavenumbers for interacting groups and noting changes in peak intensity.

Several instruments were employed to characterize the morphology of the composite membrane. Surface and cross sectional images of the composite membrane were gathered using a field emission scanning electron microscope (LEO 1550). Additionally, transmission electron microscopy (Philips 420T) cross sectional images were taken of the membrane. For both instruments cross sectional samples were embedded in epoxy and microtomed.

Results and Discussion

Spectroscopic Results:

FTIR spectra were taken in order to investigate the changes in the chemical environment between the polymer and zeolite once the ZSM-2 surface had been functionalized.

A sample consisting of polyimide, untethered ZSM-2, and APTES was prepared using the same concentrations as in the membrane fabrication process. However, immediately after adding APTES to the solution, the solution phase separated. This sample was never made successfully, and no spectra were collected with it.

The IR spectrum for the pure APTES showed a characteristic N—H stretching peak at 3382 cm⁻¹ corresponding to the primary amine [Tsapatsis, M.; Lovallo, M.; Davis, M.; Microporous Materials. 1996, 381-388]. FTIR spectra were also obtained for the polyimide, the polyimide and untethered ZSM-2, and the MMM solution in the 3600 cm⁻-2600 cm⁻¹ range.

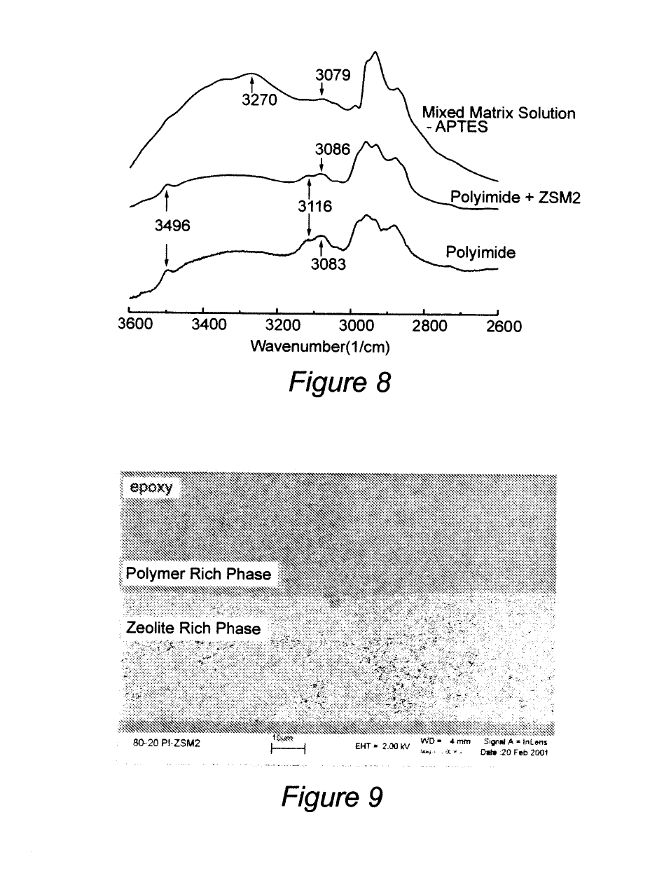

The Mixed Matrix Solution—APTES spectrum was optimized for this range by adjusting the magnitude of the pure APTES spectrum that was subtracted from the mixed matrix solution spectrum. The resulting curve removes the influence of self-associated amine groups that would be present in the pure APTES spectra, and leaves only the hydrogen bonded amine groups interacting with the carboxylic groups of the polyimide. The spectra are shown in FIG. 8.

These three curves appear to support the expected results of the experiment, specifically, successful functionalization of the zeolites with amine groups, and promotion of hydrogen bonding between these amine groups and the carboxylic groups located along the polyimide backbone. The polyimide curve displays a broad band ranging from 3500 cm⁻¹ to about 3200 cm⁻¹ and corresponding to —OH stretch associated with the carboxylic acid groups. While the 3500 cm⁻¹-3200 cm⁻¹ region of the spectrum indicates no change between the polyimide and the polyimide and untethered zeolite curves, in the subtracted mixed matrix spectrum this region shows the appearance of additional bands. This region contains the N—H stretch near 3400 cm⁻¹ and the hydrogen bonded N—H stretch near at 3270 cm⁻¹ of the amine, suggesting interaction between the ZSM-2 and the polyimide.

The 3150 cm⁻¹-3050 cm⁻¹ region of the polyimide and polyimide & ZSM-2 curves contains two peaks associated with the carboxylic group of the polymer. The left and smaller peak at 3116 cm⁻¹ results from unassociated carboxylic groups while the right peak at 3083 cm⁻¹ reflected the presence of self associated (i.e. hydrogen bonded) carboxylic groups. These peaks decrease in intensity in the mixed matrix curve due to the introduction of the amine groups which hydrogen bond with the carboxylic groups. To further support the interpretation of these results, the amine groups in pure APTES have an absorption at 3382 cm⁻¹ groups, whereas the tethered amine groups in the mixed matrix solution resonate at 3270 cm⁻¹ . This shift to a lower wavenumber was taken as an indication of the presence of hydrogen bonding between amine groups and carboxylic groups.

Microscopy Results:

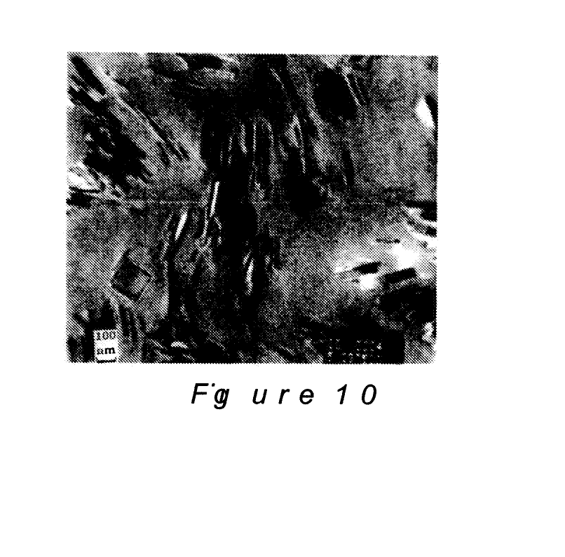

Several microscopy instruments provided detailed images of the membrane surface and interior at different magnifications. A field emission scanning electron microscope (FESEM) cross sectional image was taken, that revealed a membrane with two distinct regions: a polymer rich region and a zeolite rich region shown in FIG. 9.

Exploring both surfaces of the membrane using the FESEM confirmed that one surface contained a miniscule amount of ZMS-2, while the opposite surface carried a high concentration of the zeolite. Presumably, this sedimentation occurred during the membrane fabrication process as a result of the difference in the densities between THF (ρ=0.886 g/cm³) and ZSM-2 (ρ=1.31 g/cm³). The surface FESEM images gathered of the zeolite rich surface did not reveal the presence of voids between the polymer and the zeolite. Images taken of the same surface at lower magnifications revealed that the zeolite was well distributed across the surface and not agglomerated together, suggesting the modified ZSM-2 has an affinity for the polymer.

Transmission Electron Microscopy images (TEM) taken of the cross section of the same membrane indicated that as these zeolites sediment, many of them appear to have a preference to orient themselves such that their largest face (i.e. hexagonal face) becomes parallel to the membrane surface as shown in FIG. 6. This orientation results in the largest ZSM-2 face being positioned orthogonal to the gas flux, and provides more zeolite surface area for the gas molecules to encounter.

This may be due to the hydrodynamic radius of the large zeolite. Although this phenomenon has not been pursued further as of yet, this orientation could yield better separation performance than the same membrane without the zeolite orientation.

Permeation Data:

The permeation properties of pure polyimide and mixed matrix membrane are summarized below in Table 2. All membranes tested had a thickness approximately 62 μm.

TABLE 2
Permeability Values for Different % Weight Zeolite Membranes

| | Permeability (Barrers) | | | | |
|---|---|---|---|---|---|
| % Weight ZSM-2 | He | CO₂ | O₂ | N₂ | CH₄ |
| 0% | 35.58 | 21.97 | 4.55 | 0.97 | 0.73 |
| 20% | 30.98 | 15.96 | 5.73 | 1.2 | 0.66 |

The permeability of the MMM dropped noticeably for He and CH₄ and significantly for CO₂ (27%). This suggests that the membrane did not contain the voids encountered by others. Interestingly, O2 and N2 permeabilities both increased by roughly 25%. The changes in permeation among the gases reflected the changes in the diffusion coefficients between the two membranes. D_{O2} and D_{N2} both increased by roughly 25%, while the other gas diffusion coefficients dropped as much as 37% (i.e. CO₂). The solubilities of most of the gases increased in the MMM with CO₂ showing the largest increase at 17%; S_{N2} was the only solubility coefficient which decreased (−1%).

The diffusion and solubility coefficients are summarized in Table 3, while the ideal selectivities for certain gas pairs are summarized in Table 4.

TABLE 3
Diffusion and Solubility Coefficients for Different % Weight Zeolite Membranes

| | Diffusion Coefficient | | | | | Solubility Coefficient | | | | |
|---|---|---|---|---|---|---|---|---|---|---|
| % Weight | (1 × 10⁻⁸ cm²/s) | | | | | (cm³ (STP)/cm³ atm) | | | | |
| ZSM-2 | He | CO₂ | O₂ | N₂ | CH₄ | He | CO₂ | O₂ | N₂ | CH₄ |
| 0% | 763.6 | 3.04 | 9.65 | 4.31 | 0.69 | 0.035 | 5.49 | 0.36 | 0.17 | 0.80 |
| 20% | 536.9 | 1.89 | 11.92 | 5.38 | 0.58 | 0.04 | 6.42 | 0.37 | 0.17 | 0.87 |

TABLE 4
Ideal perm-selectivities for Different % Weight ZSM-2

| | Ideal Selectivities | | | | |
|---|---|---|---|---|---|
| % Weight ZSM-2 | O₂/N₂ | CO₂/CH₄ | N₂/CH₄ | He/CO₂ | O₂/CH₄ |
| 0% | 4.67 | 30.23 | 1.38 | 1.62 | 6.26 |
| 20% | 4.78 | 24.18 | 1.82 | 1.94 | 8.68 |

Although the selectivity of the O₂/N₂ separation was largely unchanged, the MMM provided a significant improvement when compared to the pure polyimide membrane due to the increase in permeation of O₂. Despite ZSM-2's good separation performance of CO₂/N₂ mixtures [Alpert, N.; Keiser, W. E.; Szymanski, H. A.; IR-Theory and Practice of Infrared Spectroscopy, Plenum Publishing Corporation, New York], the MMM performed poorly when compared to the pure polyimide membrane or the pure zeolite. This may be due the absence of calcination of the zeolites when in the MMM, leaving only a fraction of the ZSM-2 pore open for gas molecules. Furthermore, ZSM-2 does not separate based on size exclusion (pore size of 0.79 nm), but rather a preferential adsorption of CO₂ and unsaturated hydrocarbons on the cation sites. This phenomenon may be why CO₂ possessed the largest increase in solubility.

To realize the MMM's true separation ability, a mixed gas mixture should be used to evaluate the permeation properties. Using a gas mixture such as CH₄ and C₂H₄, or CO₂ and N₂ may reveal larger improvements in the selectivity for this MMM compared to the polyimide membrane. Furthermore, some of our recent work has focused on using zeolites that do not require calcination. Finally, annealing the membranes will most likely improve their performance.

Conclusions

In this study mixed matrix membranes were fabricated from a 6FDA-6FpDA-DABA polyimide and modified ZSM-2 zeolite. The ZSM-2 zeolites were functionalized with amine groups by reacting them with aminopropyltrimethoxysilane in toluene. Mixed matrix membranes were fabricated at 20% weight zeolite and 50% weight zeolite successfully, however the latter was too brittle to be used to gather data. The amine tethered zeolites interacted through secondary forces with the carboxylic groups along the polymer backbone as documented by FTIR studies. Band shifts associated with hydrogen bonding of the carbonyl and amine groups were observed in the spectra. These interactions promoted adhesion between the two components. The morphology of the MMM was documented by SEM and TEM studies and verified the absence of voids around the zeolites. This suggested that the zeolite and polymer had good contact at the interface. Permeation data of He, CO₂, O₂, N₂, and CH₄ were collected and analyzed. The solubility coefficient for each gas increased, except for N₂, which was largely unchanged. The changes in permeability for each gas correlated well with the change in the diffusion coefficient. The permeabilities of He, CO₂ and CH₄ all decreased, while O₂ and N₂ increased.

The present inventors additionally have invented mixed matrix membranes comprising an amine-functionalized (such as, e.g., aminopropylsilyl, pyrimidine-propylsilyl, pyrrolidine-propylsilyl, and polyethyleneimine, etc.) silica (with preferred examples of a silica being, e.g., a mesoporous silica (such as, e.g., MCM-41, MCM-48, and SBA-16, etc.); a microporous silica; etc.) and a membrane-forming polymer (such as, e.g., polysulfones, polyimides, cellulose acetates, polycarbonates, etc.). It has been discovered by the present inventors that silica may be used to construct a mixed matrix membrane having desirable characteristics (such as, e.g., selectivity for carbon dioxide, permeability, etc.). In exemplary embodiments the mixed matrix membranes made from silica (such as, e.g., well-ordered mesoporous silica, etc.) have favorable selectivity characteristics while also providing advantageous permeability characteristics.

Examples of silica useable in the invention are, e.g., a MCM-41 silica; a MCM-48 silica; a SBA-15 silica; a SBA-16 silica; mesoporous silica; microporous silica; a silica having microporous and mesoporous structure; a well-ordered, high surface area silica; a silica having an external diameter in a range between about 20 to 50 nanometers; etc. Silica may be of different geometry and different sizes.

The term “mesoporous silica” is used with its ordinary meaning in the art, namely, a silica material having mesopores, which are pores in the 2 -50 nanometer ranges (20 -500 angstroms), but having pores larger than “micropores” (another term used in the art), i.e., smaller than macropores. Mesoporous silica may be of different geometry and different sizes. Examples of a mesoporous silica are, e.g., MCM-41 (hexagonal phase), MCM-48 (cubic phase), MCM-50 (lamellar phase), SBA-1 (cubic phase), SBA-2 (three-dimensional hexagonal phase), SBA-3 (two-dimensional hexagonal phase), SBA-11 (cubic phase), SBA-12 (three-dimensional hexagonal phase), SBA-15 (two-dimensional hexagonal phase), SBA-16 (cubic cage structure), etc. For the mesoporous silica used in the invention, an average pore diameter of 20 angstroms (2 nanometers) is preferred.

Well-ordered, high-surface area silica (such as, e.g., MCM-41, MCM-48, SBA-15, SBA-16, etc.) are preferred for use in the invention. SBA-15 and SBA-16 silicas have both microporous and mesoporous structural character; MCM-41 and MCM-48 are mostly composed of well-ordered mesoporosity. These mesoporous materials can have very small diameters (e.g., in a range submicron (i.e., at most 1 micrometer), more preferably between 20 to 300 nanometers, and even more preferably 20 to 50 nanometers), which facilitates their incorporation into the polymer matrix. Examples of very small diameters are, e.g. a 1 micrometer MCM-48; a 0.03 micrometer MCM-41; a 0. 1-0.3 micrometer mesporous silica; etc.

An example of “well-ordered” silica particles are silica which are crystalline and which, as a result, have a distinct X-ray scattering pattern (see FIGS. 13A-B). Silica particles that are not well-ordered will not be able to give rise to a scattering pattern with distinct peaks.

As the membrane-forming polymers for use in the invention, examples have been mentioned including, e.g., polysulfones, polyimides, cellulose acetates and polycarbonates as non-limiting examples. Polysulfone is preferred as a membrane-forming polymer to use with mesoporous silica because of the inexpensive cost of polysulfone, while providing favorable results for selectivity and permeability.

For making a mixed matrix membrane comprising silica and a polymer, a well-ordered, high-surface area silica may be added to the membrane-forming polymer (such as, e.g., a polymer in solution; a polymer in a melt state). Advantageously, the well-ordered, high-surface area mesoporous silica may be added to the polymer (e.g., added as an additive) without the silica needing first to be super-washed.

When the membranes being synthesized are to be used as permeable selective membranes, preferably the introduction of voids are avoided and any voids are minimized in size (such as having no voids bigger than 100 angstroms, or, more preferably, having no voids altogether). Void minimization is favored by synthesizing the membranes from mesoporous silica and a membrane-forming polymer. Membranes synthesized from MCM-41, MCM-48, and SBA-16 mesoporous silica and polysulfone have been discovered to have desirably low void content.

When a mesoporous silica is used to make a mixed matrix membrane, including a surface active agent adhered to said mesoporous silica is optional but not necessary. Optionally, the mesoporous silica and the membrane-forming polymer are bonded to each other by at least one of hydrogen, covalent, and ionic bonds between said surface agent on said mesoporous silica and said membrane-forming polymer.

When a mesoporous silica is used to make a mixed matrix membrane, optionally there may be performed a step of functionalizing the mesoporous silica to include functional groups. When a mesoporous silica is used with a membrane-forming polymer to make a mixed matrix membrane, optionally there may be performed a step of functionalizing the polymer with functional groups. It should be understood that a functionalizing step (such as, e.g., a functionalizing step using APTES) is optional, and not required, for synthesizing a mixed matrix membrane from a mesoporous silica and a membrane-forming polymer. However, functional groups can be attached to mesoporous silica channels to enhance the selectivity of mixed matrix membrane. For example, facilitated transport and CO₂ separation may be enhanced by increasing diffusivity and introducing amine functional groups (such as, e.g., aminopropylsilyl, pyrimidine-propylsilyl, pyrolidine-propylsilyl, and polyethyleneimine, etc.) into mesoporous silica that have specific interaction with CO₂ molecules.

In making a mixed matrix membrane using a mesoporous silica and a membrane-forming polymer, there optionally may be included at least one step of sonicating a solution in which the polymer is dissolved.

### EXAMPLE 2

### Polysulfone and Mesoporous Molecular Sieve Mixed Matrix Membranes for Gas Separation

Introduction

Polymeric membranes have been very successful in addressing industrially important gas separations, thereby providing economical alternatives to conventional separation processes. However, polymeric membranes for gas separations have been known to have a trade-off between permeability and selectivity as shown in upper bound curves developed by Robeson. [Robeson, L. M., J. Membr. Sci. 1991, 62, 165.] Many research efforts have been aimed at modifying the backbones and side-chains of polymers experimentally in order to surpass the permeability-selectivity tradeoff. This has been difficult to achieve and in fact also, as shown by Freeman [Freeman, B. D., Macromolecules 1999, 32, 375], theoretically improbable. Thus, the use of polymeric materials as membranes has technical limitations. [Koros, W. J.; Fleming, G. K., J. Membr. Sci, 1993, 83, 1.]

In order to enhance gas separation membrane performances, recent work has focused on enhancing polymer selectivity and permeability by fabricating mixed matrix membranes (MMMs). The incorporation of various inorganic materials, such as zeolites or carbon molecular sieves, into a polymer matrix has been investigated. [Mahajan, R.; Koros, W. J., Ind. Eng. Chem. Res. 2000, 39, 2692; Mahajan, R., Koros, W. J., Polym. Eng. Sci. 2002, 42, 1420, 1432; Kulprathipanja, S.; Neuzil, R. W., Li, N., U.S. Pat. No. 4,740,219 (1988).] However, when using zeolites, poor interaction occurs with the polymer matrix and the relatively small zeolite pores. Transport limitations can also occur after modification of the external surface of the zeolite with silane coupling agents which can block pore access. [Pechar, T. W.; Kim, S.; Vaughan, B.; Marand, E.; Baranauskas, V.; Riffle, J.; Jeong, H. K.; Tsapatsis, M., J. Membr. Sci. (2005); Pechar, T. W.; Kim, S.; Vaughan, B.; Marand, E.; Tsapatsis, M.; Jeong, H. K.; Cornelius, C. J.; J. Membr. Sci. 2005.] Weak interactions between a glassy polymer matrix and inorganic molecular sieves may lead to the formation of nonselective voids resulting in Knudsen flow. [Mahajan et al. (2002), supra.]

Since the discovery of the M41 S family of mesoporous molecular sieves by Kresge et al. [Kresge, C. T.; Leonowicz, M. E.; Roth, W. J.; Vartuli, J. C.; Beck, J. S., Nature 1992, 359, 710; Beck, J. S.; Vartuli, J. C.; Roth, W. J.; Leonowicz, M. E.; Kresge, C. T.; Schmitt, K. D.; Chu, C. T. W.; Olson, D. H.; Sheppard, E. W., McCullen, S. B.; Higgins, J. B.; Schlenker, J. L., J. Am. Chem. Soc. 1992, 114, 10834], these materials have received widespread interest as catalysts, adsorbents and membranes because of their high surface areas, tunable pore sizes (2-50 nm) and surface chemistry via functionalization. The surface of mesoporous silica is decorated with reactive silanol groups, which can be used for surface modification to introduce favorable interactions with polymers. Surface functionalization of mesoporous materials with several types of functional groups for application in adsorption and catalysis has been reported. [Zhao, X. S.; Lu, G. Q., J. Phys. Chem. B, 1998, 102, 1556; Feng, X.; Fryxell, G. E.; Wang, L.; Kim, A. Y.; Liu, J.; Kemner, K. M., Science 1997, 276, 923; Xu, X.; Song, C.; Andresen, J. M.; Miller, B. G.; Scaroni, A. W., Energy Fuels 2002, 16, 1463; Huang, H. Y.; Yang, R. T.; Chinn, D.; Munson, C. L., Ind. Eng. Chem. Res., 2003, 42, 2427; Kim, S.; Ida., J.; Guliants, V. V.; Lin, Y. S., J. Phys. Chem. B, 2005, 109, 6287.] Recently, the application of these molecular sieves as membranes has been investigated by some research groups. Nishiyama et al. fabricated mesoporous MCM-48 membranes on a porous alumina support and reported that the permeation of gases through calcined MCM-48 membranes was governed by Knudsen diffusion. [Nishiyama, N.; Park, D. H.; Koide, A.; Egashire, Y.; Ueyama, K., J. Membr. Sci., 2001, 182, 235; Nishiyama, N.; Park, D. H.; Egashira, Y.; Ueyama, K., Sep. Purif Technol., 2003, 32, 127.] Reid et al. reported polysulfone (PSF) MMMs with mesoporous silica MCM-41 for gas separation. [Reid, B. D.; Ruiz-Trevino, F. A.; Musselman, I. H.; Balkus, K. J.; Ferraris, J. P., Chem. Mater., 2001, 13, 2366.] They showed that mesoporous materials offered the favorable effect of increasing the permeability of the polysulfone MMMs without decreasing its selectivity due to its good compatibility with the polymer matrix. However, their study focused on MCM-41 silica, which has one-dimensional pore channel structure prone to diffusion limitations and pore blockage. [Morey, M. S.; Davidson, A.; Stucky, G. D., J. Porous Mater., 1998, 5, 195.] In addition, due to their micrometer scale in particle size (around 0.7 μm) the composite membrane was extremely brittle and tended to crack at 30 wt % loading. Therefore, the present inventors consider nano-sized MCM-41 and cubic phase mesoporous silica (such as, e.g., MCM-48 and SBA-16) more attractive than two-dimensional MCM-41 for potential applications in molecular sieves in high performance MMM areas due to its higher loading and three-dimensional interconnected cubic pore structure.

The following experimentation relates to novel hybrid membranes based on mesoporous molecular sieves dispersed inside a polymer matrix. Hexagonal phase(such as, e.g., nano-sized MCM-41), cubic phase (MCM-48), and cubic cage structures with micropores (such as, e.g., SBA-16) mesoporous silica were choosed for representing mesoporous silica materials and fabrication of mesoporous silica and polymer hybrid membranes. Mesoporous silicas were synthesized by a templating method and characterized with X-ray diffraction (XRD), pore size analysis, and field emission scanning microscopes (FESEM). The structure, the absence of defects, and the properties of mesoporous silica/PSF MMMs were characterized by FESEM, sorption studies and gas permeation measurements.

Experimentation.

Synthesis of nano-sized MCM-41 silica. Mesoporous MCM-41 silica with a particle size of 20-50 nm was synthesized according to a previously published procedure. [Suzuki, K.; Ikari, K.; Imai, H. J. Am. Chem. Soc. 2004, 126, 462.] In this method, 3.5 g tetraethoxysilane (TEOS, Alfa-Aesar Chemical) was added to a 30 g of hydrochloric acid solution (pH 2.0) at room temperature, previously dissolving 2.6 g of cetyltrimethylammonium chloride (CTAC, Sigma-Aldrich) and 2.0 g of triblock copolymer (Pluronic F127; EO₁₀₆PO₆₀EO₁₀₆, Sigma) as cationic and nonionic surfactants, respectively. After being stirred for 4 hours, 3.0 g of 14.7 M ammonia water (NH₄OH, 28 wt %; Fisher) was added to the solution. The gel was aged at room temperature for 24 hour and then was dried at 333° K in air for 24 hours. The surfactants were removed from the dried products by calcination at 873° K in air for 3 hours with heating rate 1° K/min. In order to obtain a fine MCM-41 silica particle, a combination of sonication and sedimentation was performed. Following these steps, the MCM-41 silica was vacuum-dried overnight in order to be used in the fabrication of MMM.

Synthesis of MCM-48 Silica. Mesoporous MCM-48 silica was synthesized according to a previously published procedure. [Nishiyama et al. (2001), supra; Nishiyama et al. (2003), supra.] In this method, the aqueous micellar solution containing a quaternary ammonium surfactant, C₁₆H₃₃(CH₃)₃NBr (CTAB, Sigma-Aldrich), NaOH, and deionized water was prepared under stirring for 1 hour. Then, the solution was added to tetraethylorthosilicate (TEOS, Alfa-Aesar Chemical). The molar composition of the mixture was 0.59 CTAB: 1.0 TEOS: 0.5 NaOH: 61 H₂O. The mixture was stirred for 90 minutes and transferred to an autoclave. The reaction was carried out at 363° K for 96 hours. The MCM-48 silica was filtered, and washed with deionized water. At this stage, the as-synthesized MCM-48 still contained organic templates. Calcined MCM-48 silica used in the fabrication of MMMs was obtained after as-synthesized MCM-48 silica was calcined in air at 723° K for 5 hours. In order to obtain a fine MCM-48 silica particle, a combination of sonication and sedimentation was performed. Following these steps, the MCM-48 silica was vacuum-dried overnight in order to be used in the fabrication of MMM.

Synthesis of SBA-16 Silica. Mesoporous SBA-16 silica was synthesized according to a previously published procedure [Van Der Voort, P.; Benjelloun, M.; Vansant, E. F. J. Phys. Chem. B 2002, 106, 9027]. In this method, 4.0 g of triblock copolymer (Pluronic F127; EO₁₀₆PO₆₀EO₁₀₆, Sigma) was dissolved in 30 g of deionized water and 120 g of HCl (2M) at room temperature. 10.0 g tetraethoxysilane (TEOS, Alfa-Aesar Chemical) was added to the solution. The mixture was stirred at room temperature for 10 hour followed by heating at 353° K for 24 hour. The solid products were filtered and washed with deionized water repeatedly. After drying at room temperature overnight, the surfactants were removed from the dried products by calcination at 873° K in air for 3 hours with heating rate 1° K/min. In order to obtain a fine SBA-16 silica particle, a combination of sonication and sedimentation was performed. Following these steps, the SBA-16 silica was vacuum-dried overnight in order to be used in the fabrication of MMM.

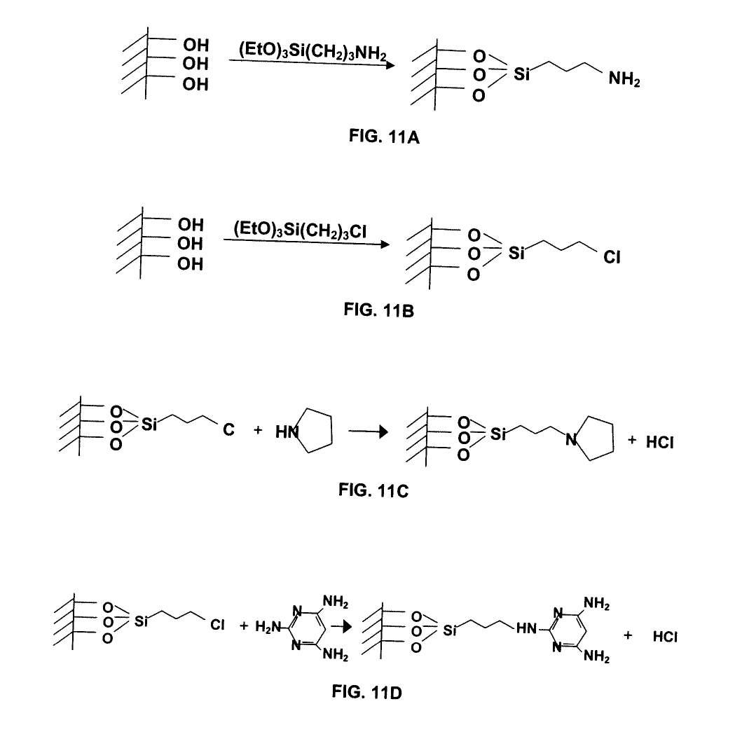

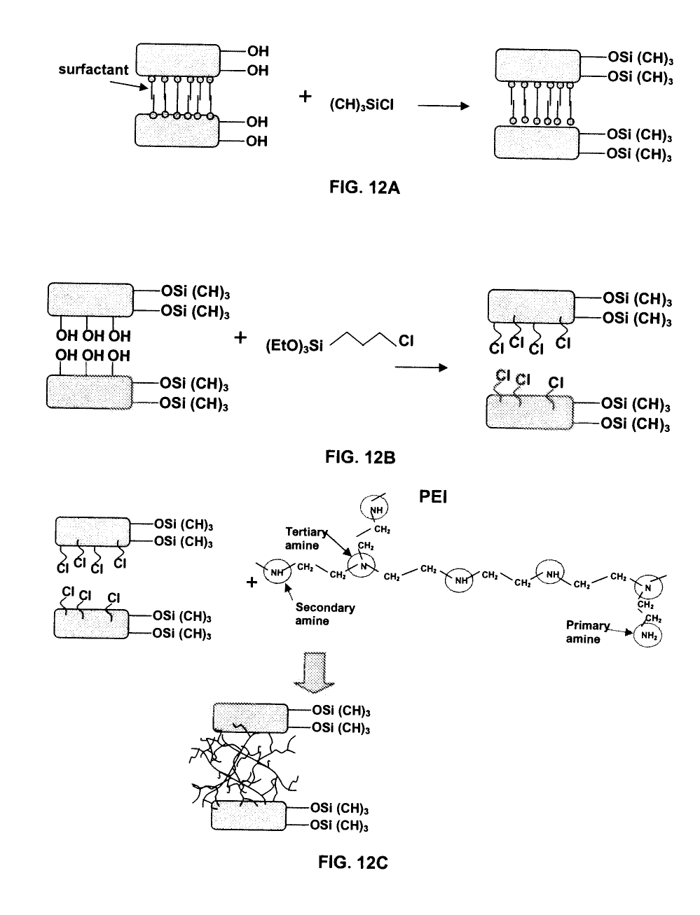

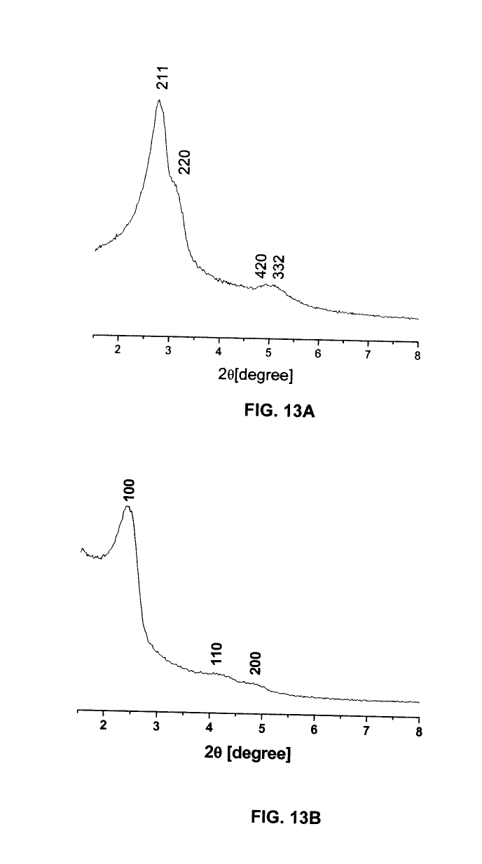

Amino group attachment to the surface of mesoporous silica. Mesoporous silica was functionalized with amine groups according to a previously published procedure [Kim et al. (2005), supra]. Several kinds of amino groups shown in FIG. 11 were attached to the surface of the mesoporous silica by treating the surface with amino group-containing silicon alkoxides. The calcined mesoporous silica powders were heated for 4 hour at 523 K in dry air to remove all adsorbed moisture except the surface OH groups. After cooling in dry air, the mesoporous silica powders were treated with amino group-containing silicon alkoxides, such as 3-aminopropyltriethoxysilane (FIG. 11A), dissolved in toluene under reflux for 2 hour to form covalent linkages with the mesoporous silica surface. For a hindered amine attachment, such as pyrrolidine or pyrimidine, a 2-step attachment procedure was employed instead which relied on surface attachment of 3-chloropropyltriethoxysilane (FIG. 11B) followed by the surface N-alkylation with pyrrolidine (FIG. 11C) or pyrimidine (FIG. 11D). The excess amines were removed by Soxhlet-extraction with methylene chloride (CH₂Cl₂) for 8 hour and the amine-modified silicas were dried at room temperature. For polyethylene (PEI) attachment to mesoporous silica channels, the external surface of as-synthesized mesoporous silica prior to surfactant was first silylated with trimethylsiane to avoid the attachment of PEI to the external surface of mesoporous silica (FIG. 12A). The surfactant was removed by Soxhlet extraction in a mixture of methanol and HCl at 393 K and then mesopore channels of mesoporous silica was treated with 3-chloropropyltriethoxysilane (FIG. 12B). The chloropropyl-modified mesoporous silica was functionalized with branched PEI (M.W.=600, Aldrich) by the nucleophilic substitution of the chlorine with the amino group in a THF solution for 5 hours at 353 K (FIG. 12C). Excess PEI was removed by Soxhlet extraction with methylene chloride (CH₂Cl₂) for overnight and dried at room temperature.

Fabrication of PSF membranes. Before fabrication of membranes, PSF (UDEL P-3500, Solvay) was degassed at 413° K for 3 hours under vacuum to remove adsorbed water. Then, 0.6 g of the PSF was dissolved in 3 mL of chloroform and stirred for one day leading to a viscous solution. The membranes were cast onto a glass substrate using a doctor blade. The glass substrate was covered with a glass cover to slow the evaporation of solvent, allowing for a film with a uniform thickness without curling. The solutions were given 1 day to dry at room temperature. Once dry, the films were placed under vacuum and the temperature was raised to its glass transition temperature, 458° K for 1 hour and then cooled down to room temperature. A 6.35 cm diameter circular sample was cut from the film and sued for permeation tests.

Fabrication of Mesoporous silica/PSF MMMs. The fabrication procedure for the mixed matrix membranes was identical to the pure polymer membrane preparation with the additional step of incorporating mesoporous silica. For a 10 wt% of mesoporous silica/PSF MMMs, approximately 0.68 g of the pure PSF was dissolved in 3 mL of chloroform and mixed for 24 hours. A predetermined mass of mesoporous silica (0.078 g) was dissolved in 1 mL of chloroform with a small amount of PSF solution (˜5 drops) and sonicated for 10 minutes to permit the dilute polymer solution to coat the mesoporous silica. This mesoporous silica solution was added to the polymer solution and the mixture was allowed to mix for 6 hours at room temperature. Following this time period, the mixture was sonicated for 10 minutes, after which it was allowed to mix for 10 minutes. This process was repeated several times. The membranes were cast onto a glass substrate using a doctor blade. The evaporation and heat treatments for the mixed matrix membranes were identical to that of the pure polymer membranes.

Characterization. The powder XRD patterns of mesoporous silica were recorded on a Scintag Inc., XD 2000 spectrometer using CuKα radiation with a step size of 0.02°/s. The N₂ adsorption-desorption isotherms were collected at 77° K using Micromeritics ASAP 2020. The MCM-48 silica samples were outgassed prior to these measurements at 423° K overnight under nitrogen flow. The surface areas were calculated using the Brunauer-Emmett-Teller (BET) method, and the pore volumes and pore diameters were calculated by the Barret-Joyner-Halenda (BJH) method and Horvath-Kawazoe (H-K) method. FESEM (LEO 1550) was used to study the morphology of the membranes. Sorption studies were conducted by the gravimetric system (IGA-002, Hiden Isochema, UK). For each measurement, the samples were degassed at 403° K for 10 hours at P≦10⁻⁶ mbar. All tubings and chambers were also degassed by applying vacuum (P≦10⁻⁶ mbar). The degassed samples were then cooled down to the specified temperature (308° K) with a ramping rate of 1° K/minute. The gases used were helium (He), carbon dioxide (CO₂), oxygen (O₂), nitrogen (NO₂) and methane (CH₄) with a reported purity of 99.99% and purified again by passing through a molecular sieve trap attached to the gravimetric system. The adsorption isotherms were measured by the small stepwise pressure (or concentration) change, i.e. 100 mbar (P≦1.3 bar) and 250 mbar (P>1.3 bar). These gravimetric sorption studies were conducted at a temperature of 308+1° K and pressure range of 0.01-4 bar.

Permeabilities of the polymeric and composite membranes were measured using a constant volume varying pressure apparatus. Permeability was measured directly, and the Time Lag Method [Crank, J., The Mathematics of Diffusion; Oxford Press, London, 1990] was applied to the recorded data to determine the diffusivity coefficient. The solubility coefficient was taken as the ratio of the permeability to diffusivity coefficient. [Crank, supra] The gases used were helium, carbon dioxide, oxygen, nitrogen, and methane. Each gas possessed a purity of 99.99% and was used as received from Air Products. The feed pressure and temperature were kept constant at 4 atm and 308 K, respectively. Each gas was run through a membrane six times and the average results and the standard deviations were recorded. Permeabilities are reported in units of Barrer.

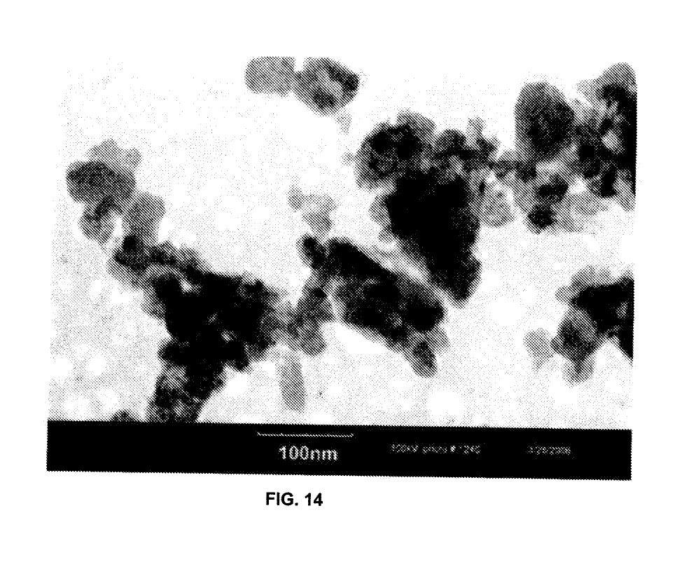

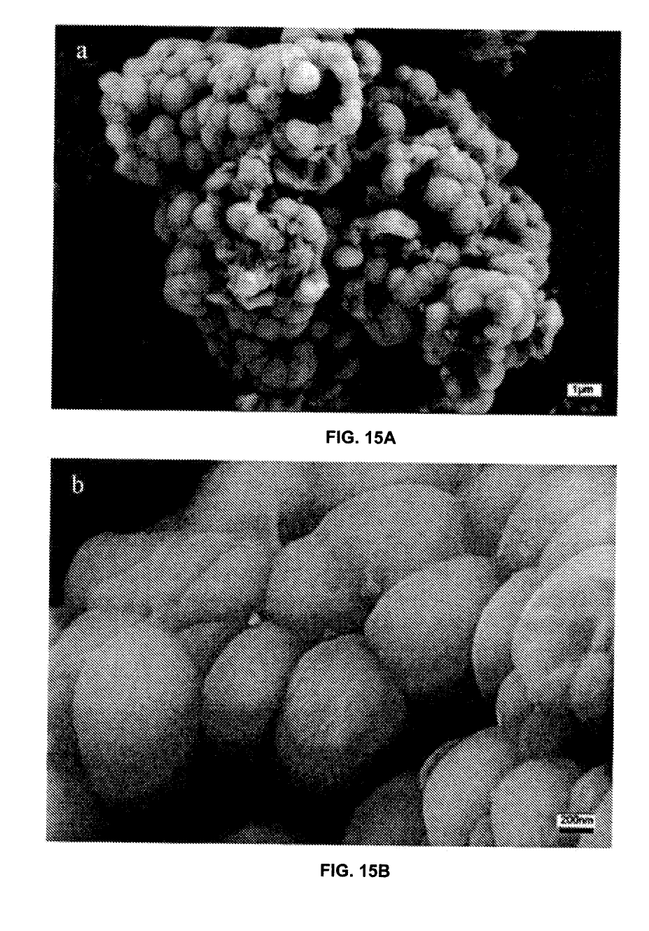

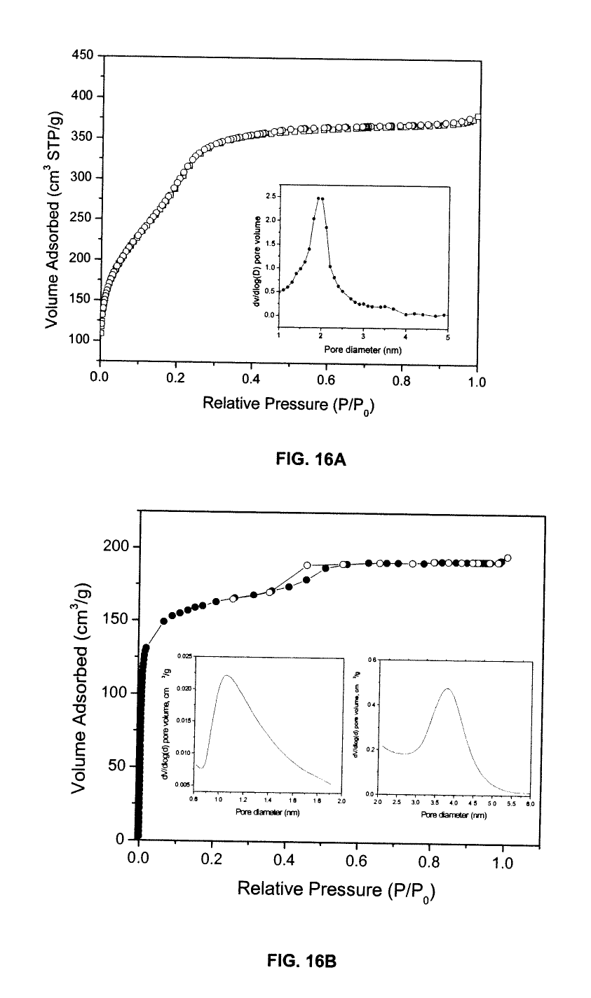

Results. The powder X-ray diffraction patterns (XRD) of the calcined MCM-48 silica and MCM-41 are shown in FIG. 13. The XRD patterns displayed Bragg peaks in the 2θ=1.5-8° range, which can be indexed to different hkl reflections. The XRD patterns of the as-synthesized (not shown here) and calcined mesoporous MCM-48 powders (FIG. 13A) consisted of the typical reflection at 2.7° (211) and weak reflections at 3.1° (220), 4.9° (420) and 5.2° (332) which corresponded to the d-spacings of ca. 32.5, 28.7, 17.7 and 17.1 angstroms, respectively. These d-spacings are indicative of MCM-48 structure possessing the cubic Ia3d space group. [Nishiayama, supra.] As shown in FIG. 13B, the diffraction peaks assigned to the 2.4° (100), 4.3° (110), and 4.9° (200) planes indicate of MCM-41 strucutre with a typical 2D hexagonal structure (P6 mm). The TEM images of MCM-41 (FIG. 14) shows that the grain sizes ranged through 20-50 nm and the particles contained hexagonally ordered mesopores. The FESEM images of the calcined MCM-48 particles in FIG. 15 show that a narrow distribution of particle sizes (˜1 μm) was obtained through a combination of sonication and sedimentation. The N₂ adsorption-desorption isotherms at 77K for the MCM-48 and SBA-16 silica is shown in FIG. 16. As shown in FIG. 16A, the N₂ adsorption isotherm of the MCM-48 is a typical reversible type IV adsorption isotherm characteristic of a mesoporous material. The MCM-48 silica had a very high surface area of around 1007 m²/g, indicating high quality. The uninomal pore size distribution was centered at 2.0 nm by BJH method. The N₂ adsorption isotherm (not shown) of the MCM-41 silica, as typical for a mesoporous material, shows high surface area of 572 m²/g, and uniform pore size distribution centered at 1.8 nm. The pore size distribution of SBA-16 shows a narrow distribution of mesopores and micropores distributed at 3.5 nm and 1.1 nm, respectively (FIG. 16B). The total surface area of SBA-16 calculated by BET method is 573 m²/g. The total pore volume of this material is 0.3 cm³/g and the micropore volume is 0.18 cm³/g based on t-plot analysis. These results are in agreement with previously published results on micellar templated mesoporous silica materials. [Kresge supra; Beck supra; Nishiyama supra; Morey supra.]

To verify the compatibility of mesoporous silica with the glassy polymer and to check for the presence of unselective voids in the mesoporous silica/PSF MMMs, permeability measurements for helium and oxygen were conducted using the PSF MMM containing 10 wt % as-synthesized MCM-48 silica (before calcinations). The external surface of uncalcined mesoporous silica is covered with surfactant molecules electrostatically bonded to the external surface. [Kruk, M.; Jaroniec, M.; Sakamoto, Y.; Terasaki, O.; Ryoo, R.; Ko, C. H., Journal of Physical Chemistry. B, 2000, 104, 292.] However, uncalcined mesoporous silica materials which have been extensively washed provide external silanol groups for surface selective modifications. [Kim supra; Stein, A.; Melde, B. J.; Schroden, R. C., Advanced Materials, 2000, 12, 1403; Juan, F. d.; Ruiz-Hitzky, E., Advanced Materials, 2000, 12, 430.] Because the pores of the as-synthesized MCM-48 silica are nonetheless filled with organic surfactant, this silica is a good system for checking wetting properties with polymers and for the presence of defects. The presence of any unselective voids at the interface between the polymer and mesoporous silica should offer pathways of high permeability for helium. The helium and oxygen permeability, oxygen diffusion and solubility coefficients for the PSF and the 10 wt % as-synthesized MCM-48 MMM are shown in Table 5.

TABLE 5
Gas permeabilities of the pure polysulfone and as-synthesized
MCM-48 MMMs

| Wt % As-syn. | He | O₂ | | |
|---|---|---|---|---|
| MCM-48 | P | P | D | S |
| 0 | 8.02 ± 0.19 | 0.98 ± 0.06 | 3.33 ± 0.17 | 0.22 ± 0.02 |
| 10 | 7.98 ± 0.12 | 0.95 ± 0.07 | 3.08 ± 0.29 | 0.24 ± 0.01 |

P = Permeability, Barrer
D = Diffusivity, 10⁻⁸, cm²/sec
S = Solubility, cm³@ STP/(cm³_{polymer} atm)

Average penneabilities of helium and oxygen dropped with the addition of MCM-48. In addition, the average diffusion coefficient of oxygen dropped, although its solubility remained the same. This result is consistent with the as-synthesized MCM-48 silica behaving as an impermeable filter and having good interaction with the polymer matrix.

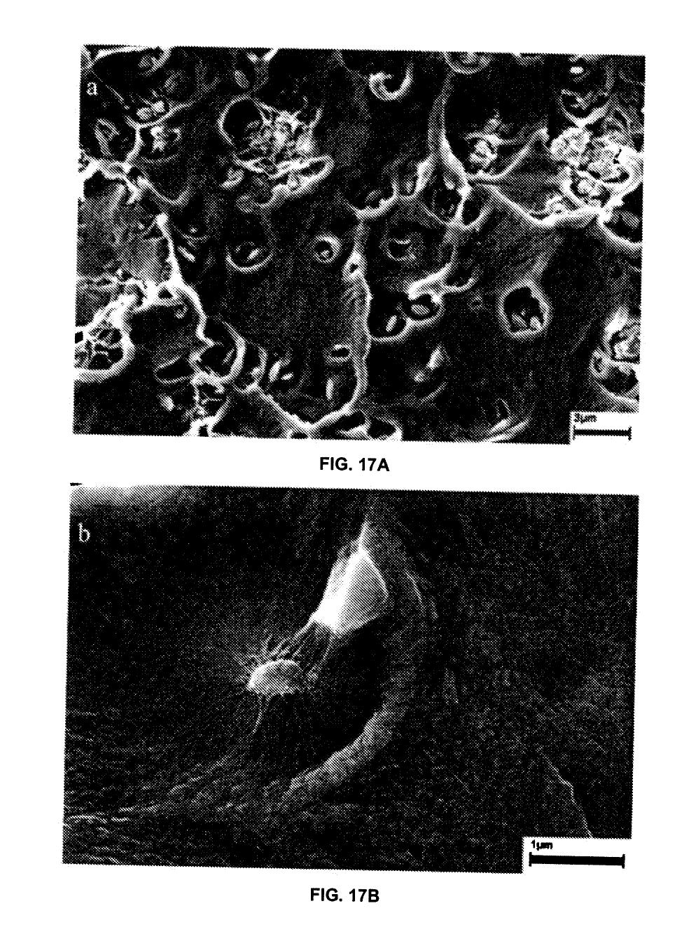

To further investigate the presence of unselective voids in MMMs, careful FESEM inspections were carried out. FESEM cross-sectional images of 10 wt % as-synthesized MCM-48/PSF MMMs are shown in FIG. 17. FIG. 17A shows that MCM-48 silica particles appear to be well dispersed through the PSF matrix and few empty cavities remain representing replicas of MCM-48 silica cleaved away when the FESEM sample was prepared with liquid nitrogen. The FESEM image at higher magnification (FIG. 17B) shows that the polymer adheres well to the MCM-48 silica particles and that no unselective voids are present around the mesoporous silica particles. The permeability and FESEM results suggest that the as-synthesized mesoporous silica added to the polymer matrix behaves as an impermeable filter, lowering the permeability of gases, and hindering the diffusion of oxygen. Furthermore, the mesoporous MCM-48/PSF MMMs show no evidence of unselective voids.

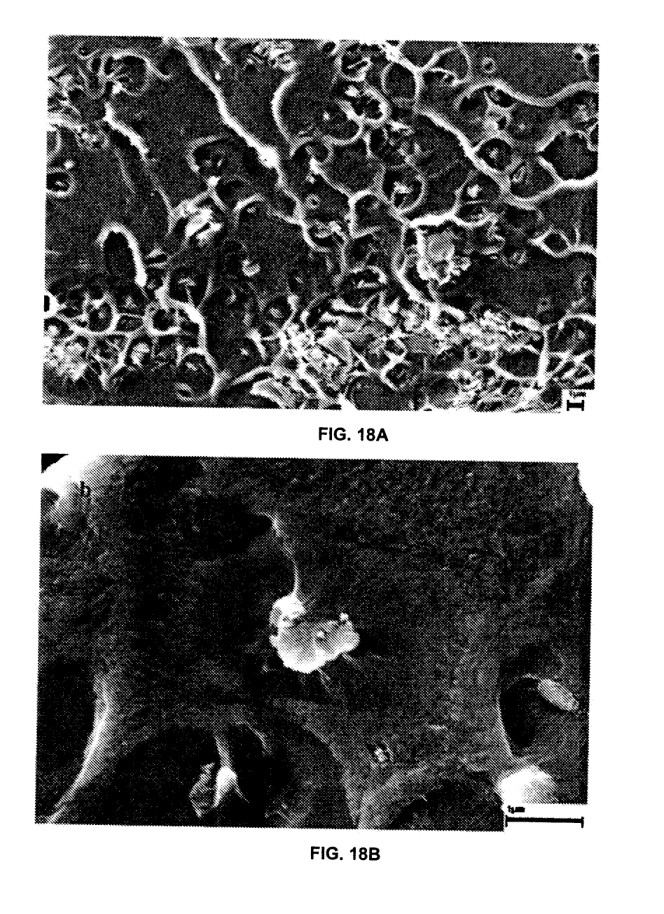

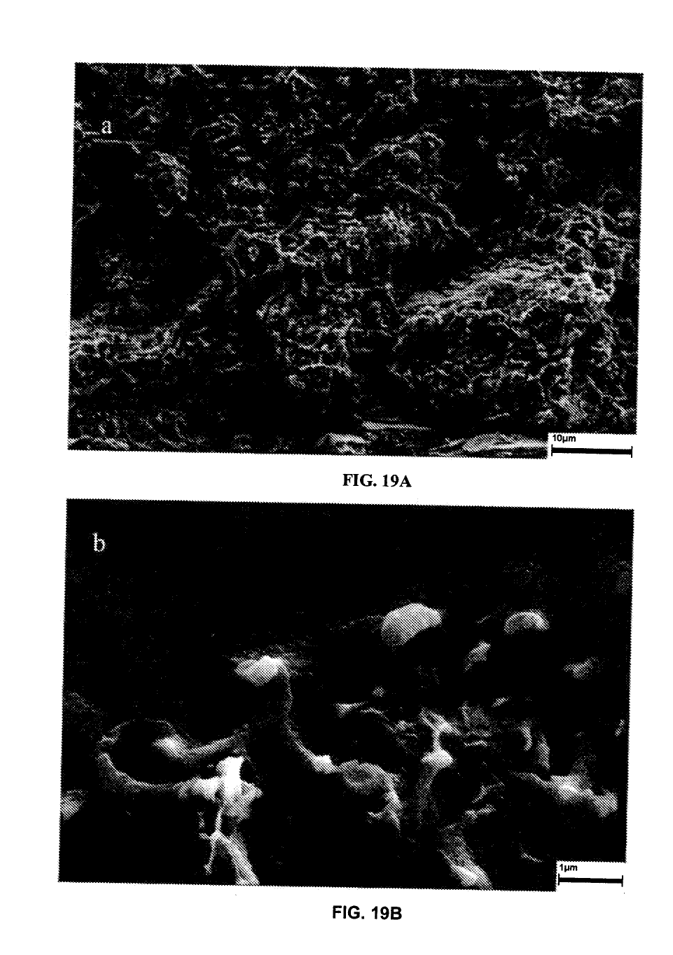

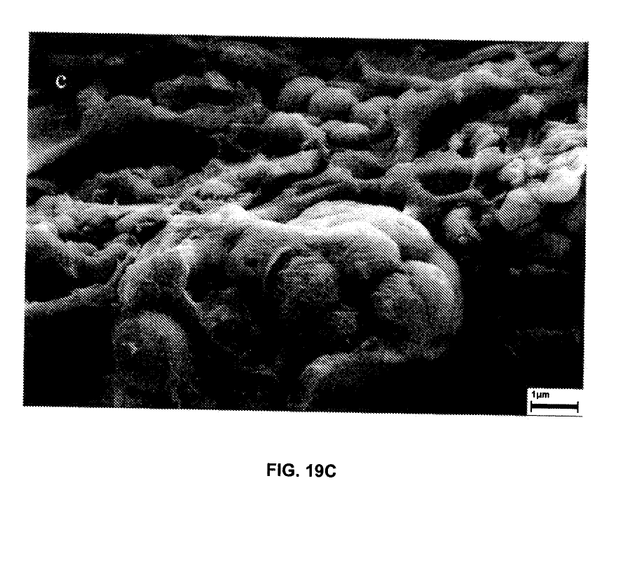

The FESEM images of 10˜20 wt % of calcined MCM-48/PSF MMMs are shown in FIG. 18-19. The FESEM results of 10 wt % of calcined MCM-48 loading are similar to that of the as-synthesized 10 wt % MCM-48/PSF MMMs. At 10 wt % of MCM-48 loading (FIG. 18A), mesoporous silica particles are well distributed throughout the PSF matrix. FIG. 18B does not show any unselective voids around calcined MCM-48 particles, suggesting better wetting properties with the polymer matrix than is exhibited by zeolites. [Mahajan (2000), supra; Duval, J.-M.; Kemperman, A. J. B.; Folkers, B.; Mulder, M. H. V.; Desgrandchamps, G.; Smolders, C. A., J. Appl. Polym. Sci., 1994, 54, 409.] The FESEM images of unmodified zeolites loaded in a glassy polymer matrix revealed the presence of unselective voids surrounding zeolite particles. In contrast to zeolite crystals, mesoporous MCM-48 silica particles are covered with weakly acidic surface silanol groups showing favorable interactions with organic molecules. [Jentys, A.; Kleestorfer, K. K.; Vinek, H., Micro. Meso. Mater., 1999, 27, 321.] A reported concentration of the surface SiOH groups is about 1.8 SiOH/nm² on the MCM-48 surface. [Kumar, D.; Schumacher, K.; du Fresne von Hohenesche, C.; Grun, K.; Unger, K. K., Coll. surf A., 2001, 187-188, 109.] Although this value includes both reactive single SiOH groups and also unreactive hydrogen-bonded SiOH groups, approximately one SiOH/nm² can be a primary adsorption site for other molecules. [Kim, supra] In an ATR-FTIR spectroscopy study, Reid et al. suggested that the phenyl oxygens of PSF interact with surface silanol groups of MCM-41 silica through hydrogen bonding. [Reid, supra] Therefore, similar hydrogen bonding interaction may occur between PSF and surface silanol groups of MCM-48, thus providing good wetting properties of MCM-48/PSF MMMs. At the 20 wt % of MCM-48 loadings, unlike 10 wt % of loading, not all MCM-48 particles are well distributed through the matrix and some MCM-48 silica particles form small domains in a polymer matrix as shown in FIG. 19A. Although some MCM-48 particles aggregate and form silica domains, higher magnification of the FESEM image in FIGS. 19B and 19C shows that isolated silica particles and the small domains of silica particles are well coated with the polymer.

TABLE 6
Gas permeabilities (Barrer) of various gases in the pure polysulfone and
mesoporous silica MMMs

| | Mesoporous | | | | | |
|---|---|---|---|---|---|---|
| Membrane | silica wt % | He | CO₂ | O₂ | N₂ | CH₄ |
| PSF | 0 | 8.02 ± 0.19 | 4.46 ± 0.10 | 0.98 ± 0.07 | 0.18 ± 0.01 | 0.17 ± 0.01 |
| MCM41/PSF | 20 | 16.25 ± 0.07 | 7.59 ± 0.14 | 1.67 ± 0.01 | 0.30 ± 0.00 | 0.31 ± 0.00 |
| | | (102.62%)^{a} | (70.18%) | (70.41%) | (66.67%) | (82.35%) |
| MCM41/PSF | 30 | 46.02 ± 0.21 | 22.93 ± 0.20 | 5.01 ± 0.21 | 0.98 ± 0.05 | 1.02 ± 0.00 |
| | | (473.82%) | (414.26%) | (411.22%) | (544.45%) | (500.00%) |
| Amine- | 20 | 13.11 ± 0.06 | 7.25 ± 0.12 | 1.35 ± 0.00 | 0.25 ± 0.00 | 0.26 ± 0.00 |
| MCM41/PSF | | (63.47%) | (62.56%) | (37.76%) | (38.89%) | (52.94%) |
| MCM48/PSF | 10 | 15.75 ± 0.53 | 8.45 ± 0.13 | 1.84 ± 0.10 | 0.32 ± 0.02 | 0.33 ± 0.02 |
| | | (96.38%)^{a} | (89.46%) | (87.76%) | (77.78%) | (94.12%) |
| MCM48/PSF | 20 | 32.10 ± 0.83 | 18.21 ± 0.41 | 4.14 ± 0.01 | 0.77 ± 0.02 | 0.77 ± 0.02 |
| | | (300.25%) | (308.30%) | (322.45%) | (327.78%) | (352.94%) |
| SBA16/PSF | 10 | 15.42 ± 0.09 | 7.70 ± 0.05 | 1.67 ± 0.00 | 0.31 ± 0.01 | 0.32 ± 0.00 |
| | | (92.27%) | (72.65%) | (70.41%) | (72.22%) | (88.24%) |

^{a}( ) increment from pure polymer

TABLE 7
Selectivity for polysulfone and mesoporous silica MMMs

| | Mesoporous | | | |
|---|---|---|---|---|
| Membrane | silica wt % | He/CH₄ | CO₂/CH₄ | O₂/N₂ |
| PSF | 0 | 46.52 | 25.88 | 5.47 |
| MCM41/PSF | 20 | 51.74 | 24.18 | 5.56 |
| MCM41/PSF | 30 | 44.90 | 22.38 | 5.11 |
| Amine- | 20 | 50.89 | 28.15 | 5.39 |
| MCM41/PSF | | | | |
| MCM48/PSF | 10 | 47.78 | 25.47 | 5.75 |
| MCM48/PSF | 20 | 41.56 | 23.58 | 5.38 |
| SBA16/PSF | 10 | 48.40 | 24.16 | 5.43 |

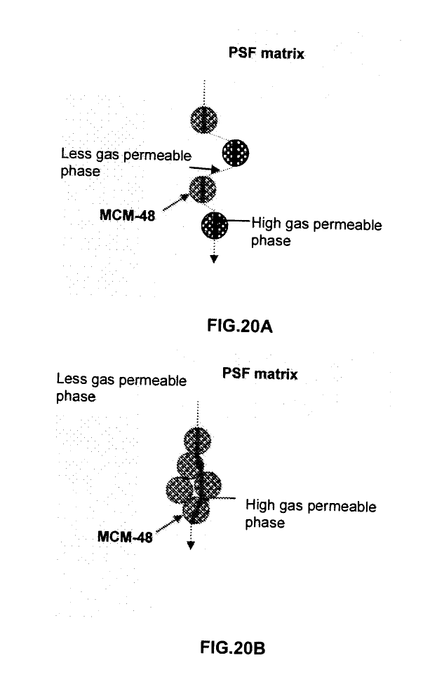

The permeability results and ideal separation factors for the mesoporous MCM-41, MCM-48 and SBA-16 silica and PSF MMMs are shown in Tables 6 and 7, respectively. Because of different polymer processing and film preparation history, permeability values for inventive pure PSF membranes in Tables 6 and 7 are somewhat lower than those previously reported by other research groups for their membranes. [Reid, supra; Gur, T. M., J. Membr. Sci, 1994, 93, 283.] For tested gases (helium, carbon dioxide, oxygen, nitrogen and methane), the permeability values increased in proportion to the amount of mesoporous silica in the polymer matrix. Addition of 10 wt % of MCM-48 or SBA-16 to PSF resulted in ˜80% increase in the permeability of each gas tested. These overall increases in permeability maintained the selectivity constant or only slightly changed as shown in Table 7. At 20 wt % of MCM-48 silica loading, the permeability increased by ˜300% for helium and carbon dioxide, and ˜320% for oxygen, nitrogen and methane, respectively. After 30 wt % of nano-sized MCM-41 silica loading, permeability increased dramatically up to around 500%. Despite these increases in permeability, the separation factor decreased only slightly or remained virtually unchanged, which is an advantageous result for the inventive membranes. In case of 20 wt % addition of amine-modified mesoporous silica, CO₂/CH₄ and CO₂/N₂ separation factor were increased from 25.88 to 28.15 and from 24.78 to 29, respectively. Therefore, this nano-sized mesoporous silica (˜20 nm) is more suitable for commercialization of MMMs with very thin selective layer than micro-sized zeolite or molecular sieves. At same time, amine functional groups attached to mesoporous silica channels can enhance CO₂ selectivity suitable for coal gasification such as CO₂/N₂ separation from flue gas. From the FESEM images at 20 wt % MCM-48 loading, MCM-48 silica particles form small domains throughout the polymer matrix. Koros et al. suggested that higher membrane performance can be achieved if the mixed matrix membrane morphology forms some continuous pathways through the filler component. [Zimmerman, C. M.; Singh, A.; Koros, W. J., J. Membr. Sci., 1997, 137, 145.] Some semblance of silica domain continuity can be seen in FIG. 16 for the MCM48/PSF MMMs. FIG. 20 illustrates simplistic, discontinuous and continuous penetrant pathways through the molecular sieving phase of MMMs. The continuous pathways present in the polymer matrix with the addition of 20 wt % of MCM-48 allow the gas molecules to diffuse solely through the molecular sieve phase such that high gas permeation performance results, while in the discontinuous phase as in the case of 10 wt % of silica loading, gas molecules are forced to diffuse through the less permeable PSF region.

TABLE 8
Diffusivity (D) and solubility(S) of various gases in the pure pure polysulfone
and mesoporous silica MMMs

| | CO₂ | | O₂ | | N₂ | | CH₄ | |
|---|---|---|---|---|---|---|---|---|
| Membrane | D | S | D | S | D | S | D | S |
| PSF | 1.11 ± 0.01 | 3.06 ± 0.07 | 3.33 ± 0.17 | 0.22 ± 0.02 | 1.05 ± 0.12 | 0.13 ± 0.01 | 0.26 ± 0.01 | 0.50 ± 0.03 |
| 20 wt % MCM41/ | 2.58 ± 0.03 | 2.24 ± 0.02 | 6.00 ± 0.24 | 0.21 ± 0.01 | 1.50 ± 0.17 | 0.15 ± 0.02 | 0.53 ± 0.01 | 0.45 ± 0.01 |
| PSF | | | | | | | | |
| 30 wt % MCM41/ | 7.64 ± 0.06 | 2.28 ± 0.02 | 16.86 ± 0.86 | 0.23 ± 0.02 | 4.02 ± 0.21 | 0.19 ± 0.00 | 1.55 ± 0.02 | 0.50 ± 0.01 |
| PSF | | | | | | | | |
| 20 wt % amine- | 2.52 ± 0.02 | 2.19 ± 0.02 | 4.75 ± 0.11 | 0.22 ± 0.00 | 1.34 ± 0.04 | 0.14 ± 0.00 | 0.41 ± 0.01 | 0.48 ± 0.01 |
| MCM41/PSF | | | | | | | | |
| 10 wt % MCM48/ | 2.06 ± 0.04 | 3.11 ± 0.07 | 5.03 ± 0.34 | 0.28 ± 0.00 | 1.35 ± 0.04 | 0.18 ± 0.01 | 0.44 ± 0.03 | 0.57 ± 0.03 |
| PSF | | | | | | | | |
| 20 wt % MCM48/ | 3.00 ± 0.03 | 4.61 ± 0.06 | 6.75 ± 0.11 | 0.47 ± 0.01 | 1.40 ± 0.25 | 0.42 ± 0.06 | 0.48 ± 0.02 | 1.21 ± 0.06 |
| PSF | | | | | | | | |
| 10 wt % SBA16/ | 1.46 ± 0.01 | 4.02 ± 0.05 | 4.01 ± 0.11 | 0.32 ± 0.01 | 0.93 ± 0.04 | 0.25 ± 0.00 | 0.29 ± 0.00 | 0.85 ± 0.01 |
| PSF | | | | | | | | |

D = 10⁻⁸, cm²/sec
S = cm³@ STP/(cm³_{polymer} atm)

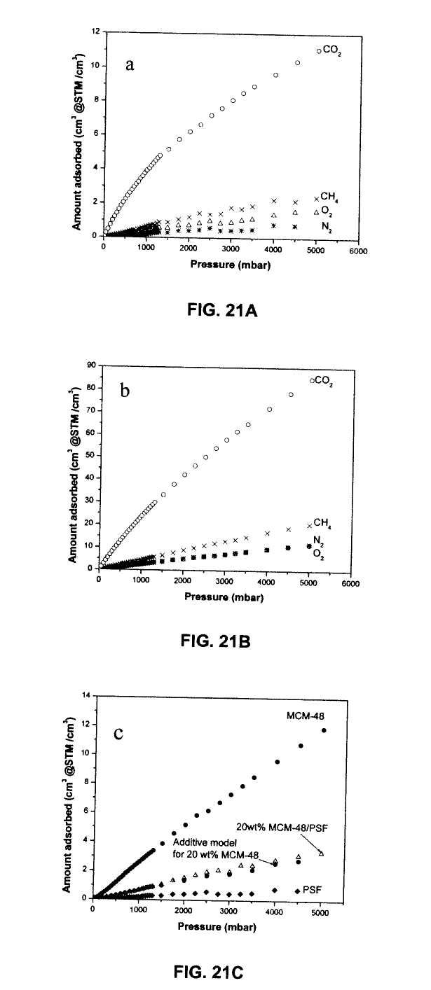

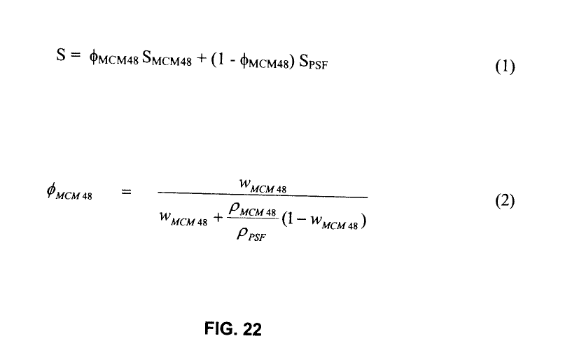

The differences in permeabilities of each MMM in this Example can be better understood by analyzing the contributions of diffusivity and solubility coefficients to the overall permeabilities. The diffusivity and solubility coefficients for tested gases are shown in Table 8. Similar to the observed increase in permeability, after the incorporation of MCM-48 silica to the polymer, diffusivity and solubility coefficients for all tested gases increased monotonically. Increases in gas permeability have been reported for polymer/silica MMMs. [Reid, supra; Merkel, T. C.; Freeman, B. D.; Spontak, R. J.; He, Z.; Pinnau, I.; Meakin, P.; Hill, A. J., Chem. Mater., 2003, 15, 109; Merkel, T. C.; He, Z.; Pinnau, I.; Freeman, B. D.; Meakin, P.; Hill, A. J., Macromolecules, 2003, 36, 8406; Moaddeb, M.; Koros, W. J., Membr. Sci., 1997, 125, 143.] The increases in the oxygen/nitrogen selectivity and oxygen permeability compared to those in a pristine polymer were observed for the polymer/silica composites by Koros et al. [Moaddeb, supra.] The increase in permeability was attributed to the disruption of polymer chain packing in the presence of the silica particles. [Id.] Also, Freeman et al. suggested that nanometer-sized fumed silica (FS) particles are able to disrupt packing of rigid polymer chains, thereby subtly increasing the free volume available for molecular transport. [Merkel (2003) supra] For example, at 20 wt % of FS loading, methane permeability in FS-filled glassy polymer is approximately 140% higher than that in the pure polymer membrane. The increase in permeability of mesoporous silica/PSF MMMs observed here is more than twice that of the FS-filled polymer membrane system suggesting that some permeation also occurs through the mesoporous silica channels. The pore size of the tested MCM-48 silica is 2.0 nm by the BJH method. However, the BJH method overpredicts the pressures of the capillary condensation/desorption, and thus underestimates the calculated pore size in typical mesoporous silica materials by about 1.0 nm, or by 25-30% as the pore size approaches 2.0 mn. [Kruk supra; Ravikovitch, P. I.; Wei, D.; Chueh, W. T.; Haller, G. L.; Neimark, A. V., J. Phys. Chem. B, 1997, 101, 3671; Ravikovitch, P. I.; Neimark, A. V., Langmuir, 2000, 16, 2419.] Thus, the MCM-48 silica pore size should be near 3.0 nm. While this may enhance gas diffusion, the pore openings may not be large enough to enable penetration of the high molecular weight polymer. Therefore, the monotonic increase in diffusivity could be a consequence of the presence of high diffusivity tunnels and redistribution of rigid polymer chain near the pore entrance. As shown in Table 8, the solubility coefficients also increase with the addition of MCM-48 silica. To better explain the increases in solubility in the MCM-48/PSF MMMs system, separation sorption studies for MCM-48, PSF and MMMs were carried out. These gas sorption isotherms are shown in FIG. 21. As shown in FIGS. 21A-21B, mesoporous MCM-48 silica has a higher adsorption capacity than PSF because of its high coverage of silanol groups on silica surface. [Kim supra; Jetys supra; Kumar supra] For porous filler particles dispersed in a continuous polymer matrix, the solubility of the composite can be modeled by [Merkel et al. supra] equation (1) in FIG. 22 where S_{MCM48} and S_{PSF} are the intrinsic solubilities of MCM-48 and PSF. The volume fraction of MCM-48 (φ_{MCM48}) has been estimated using pure component densities [Merkel et al. supra] according to equation (2) in FIG. 22, in which ρ_{MCM48} and ρ_{PSF} denote the MCM-48 silica and pure polymer densities, respectively, and w_{MCM48} is the silica weight fraction. The densities of MCM-48 and PSF used here were 1.64 and 1.24 g/cm³, respectively. [Innocenzi, P.; Martucci, A.; Guglielmi, M.; Bearzotti, A.; Traversa, E.; Pivin, J. C., J. Euro. Ceramic Soc., 2001, 21, 1985.] The calculated and experimental value of the solubility coefficients of nitrogen at 4 bar and 308K are shown in Table 5 (FIG. 19). Addition of 20 wt % of MCM-48 silica resulted in a 255% increase in the solubility of nitrogen (0.20 to 0.71 cm³ at STP/cm³_{polymer} atm)). In FIG. 21C, the predicted nitrogen uptake for PSF containing 20 wt % MCM-48 based on the pure material sorption capacities and the additive model are expressed by equation (1) in FIG. 19. The measured uptake by 20 wt % of MCM-48/PSF MMM shows a very similar trend with the gas sorption values predicted by the additive model. Table 9 (FIG. 21C) shows that the experimental solubility coefficient of MMM containing 20 wt % of MCM-48 (0.71 cm³ at STP/cm³_{polymer} atm)) corresponds to the theoretical value (0.65 cm³ at STP/cm³_{polymer} atm)). Therefore, the increase in permeability of MCM-48/PSF MMMs can be attributed to an increase in diffusivity as well as solubility.

TABLE 9
Calculated and experimental solubility coefficients of N₂ at 4 bar

| | Solubility coefficients, |
|---|---|
| | cm³@ STP/(cm³_{polymer} atm) |
| | N₂ |
| PSF | 0.20 |
| MCM48 | 2.44 |
| 20 wt % MMM | 0.71 |
| Calculated 20 wt % MMM | 0.65 |

Thus, in this Example, a mesoporous MCM-48 silica was synthesized by a templating method and mixed with polysulfone (PSF) to fabricate mixed matrix membranes (MMMs). Helium permeation data and SEM images of as-synthesized MCM-48/PSF MMMs suggest that MCM-48 silica particles adhered well to the PSF matrix and the MMMs were defect free. Gas permeation tests indicated that the increases in permeability resulted from increases in solubility as well as diffusivity. The increases in transport properties for the tested gases in this Example make mesoporous MCM-48 silica an attractive additive for enhancing the gas permeability of MMMs without sacrificing selectivity.

Mixed matrix membranes therefore can be prepared using a mesoporous silica (such as MCM-41, MCM-48, and SBA-16 silica synthesized by a templating method) and a polymer matrix (such as a polysulfone as the polymer matrix). In Example 2, the high surface coverage of silanol groups on the mesoporous silica provided good interaction with the PSF matrix. Helium permeation data and SEM images of as-synthesized MCM-48/PSF MMMs (Example 2) suggest that MCM-48 silica particles adhered well to PSF and prepared MMMs were defect free. Mesoporous silica materials offer the favorable effect of large increase in gas permeability in MMMs without sacrificing selectivity. These dramatic increases in gas permeability in Example 2 resulted from increases in solubility as well as diffusivity. The continuous pathways present in the polymer matrix with the high loading of mesoporous silica allowed the gas molecules to diffuse solely through the molecular sieve phase such that high gas permeation performance resulted. The measured uptake of MCM-48/PSF MMM showed a very similar increase in the gas sorption capacities predicted by a simple theoretical model. The observed increases in both the diffusivity and solubility make mesoporous silica an attractive additive for enhancing the gas permeability of MMMs without sacrificing selectivity. In addition, materials comprising nanosize mesoporous silica (˜20 nm) are good candidate materials for commercialization of MMMs with a very thin selective layer.

While the invention has been described in terms of its preferred embodiments, those skilled in the art will recognize that the invention can be practiced with modification within the spirit and scope of the appended claims.

We claim:

1. A mixed matrix membrane, comprising
a silica selected from the group consisting of: a MCM-41 silica; a MCM-48 silica; a SBA-15 silica; a SBA-16 silica; a microporous silica; a mesoporous silica; a silica having microporous and mesoporous structure; a well-ordered, high surface area silica; and a silica having an external diameter in a range submicron; and
a membrane-forming polymer.

2. The mixed matrix membrane of claim 1, including a well-ordered, high surface area silica wherein the silica have a distinct X-ray scattering pattern.

3. The mixed matrix membrane of claim 1, including a well-ordered, high surface area silica wherein the silica has surface area of at least 300 square meters/g.

4. The mixed matrix membrane as recited in claim 1 wherein said membrane-forming polymer is selected from the group consisting of a polyimide; a polysulfone; a cellulose acetate; and a polycarbonate.

5. The mixed matrix membrane of claim 1, including amino groups on a surface thereof.

6. The mixed matrix membrane of claim 5, wherein the amino groups are selected from the group consisting of aminopropylsilyl; pyrimidine-propylsilyl; pyrolidine-propylsilyl; and polyethyleneimine.

7. The mixed matrix membrane of claim 1, which separates carbon dioxide from an environment in which the membrane is placed.

8. The mixed matrix membrane of claim 1, including a surface active agent adhered to said silica.

9. The mixed matrix membrane of claim 1, wherein the silica and said membrane-forming polymer are bonded to each other by at least one of hydrogen, covalent, and ionic bonds between said surface agent on the silica and said membrane-forming polymer.

10. The mixed matrix membrane as recited in claim 1 wherein an interface between said silica and said membrane-forming polymer has voids no bigger than 100 angstroms.

11. The mixed matrix membrane as recited in claim 1 wherein an interface between said silica and said membrane-forming polymer is substantially void free.

12. The mixed matrix membrane as recited in claim 1, wherein the membrane-forming polymer is a hyperbranched polyimide.

13. The mixed matrix membrane as recited in claim 1, wherein the membrane-forming polymer is a linear polyimide.

14. The mixed matrix membrane of claim 1, wherein the membrane-forming polymer is a polysulfone.

15. The mixed matrix membrane of claim 14, including amino groups on at least one of a surface of the polymer and a surface of the silica.

16. The mixed matrix membrane of claim 16, wherein the amino groups are selected from the group consisting of aminopropylsilyl; pyrimidine-propylsilyl; pyrolidine-propylsilyl; and polyethyleneimine.

17. The mixed matrix membrane of claim 1 wherein the silica is a MCM-41 silica, a MCM-48 silica, a SBA-15 silica or a SBA-16 silica, and the membrane-forming polymer is polysulfone.

18. A method of making a mixed matrix membrane comprising the steps of:
combining a membrane-forming polymer with a silica to form a mixture;
casting the mixture onto a support;
removing solvent from the mixture;
annealing the mixture; and
forming a mixed matrix membrane.

19. The method of claim 18, wherein the silica is selected from the group consisting of: a MCM-41 silica, a MCM-48 silica, a SBA-15 silica; a SBA-16 silica; a microporous silica; a mesoporous silica; a silica having microporous and mesoporous structure; a well-ordered, high surface area silica; and a silica having an external diameter in a range submicron.

20. The method of claim 18, including a step of functionalizing the silica to include functional groups.

21. The method of claim 18, wherein the membrane-forming polymer is polysulfone.

22. The method of claim 18, wherein the membrane-forming polymer is hyperbranched.

23. The method of claim 18, wherein the membrane-forming polymer is linear.

24. The method of claim 18 including a step of functionalizing said polymer with functional groups.

25. A method of making a mixed matrix membrane comprising the steps of:
a) coating a substrate with a membrane-forming polymer, said polymer being present in an organic solvent, said coating step producing a polymer layer;
b) coating said polymer layer with a silica, said silica being present in an aqueous solvent, said coating step producing a silica layer on said polymer layer.

26. The method of claim 25, wherein the silica is selected from the group consisting of: a MCM-41 silica, a MCM-48 silica, a SBA-15 silica; a SBA-16 silica; a microporous silica; a mesoporous silica; a silica having microporous and mesoporous structure; a well-ordered, high surface area silica; and a silica having an external diameter in a range submicron.

27. The method of claim 26, wherein the polymer is polysulfone.

28. The method of claim 25, comprising: mixing a mesoporous silica with polysulfone to produce a mixed matrix membrane.

29. The method of claim 25, wherein the solvent is selected from the group consisting of chloroform and methyl chloride.

30. The method of claim 25, including at least one step of sonicating a solution in which the polymer is dissolved.
